(19) United States
(12) Patent Application Publication
(10) Pub. No.: US 2018/0225013 A1
(43) Pub. Date: Aug. 9, 2018

(54) NETWORK-BASED GRAPHICAL COMMUNICATION SYSTEM

(71) Applicant: Likemoji Inc., Truckee, CA (US)

(72) Inventors: Alex Barrett, Truckee, CA (US); Steven Eugene Tietze, Tahoe City, CA (US); Sergei Gorshunov, Dubai (AE)

(73) Assignee: Likemoji Inc., Truckee, CA (US)

(21) Appl. No.: 15/425,948

(22) Filed: Feb. 6, 2017

(51) Int. Cl. G06F 3/0482; G06F 3/0481; H04L 29/06

(52) U.S. Cl. CPC G06F 3/0482; H04L 67/42; G06F 3/04817

(57) ABSTRACT

Devices, systems, and methods are described herein for communicating data using a network-based graphical communication system. In one aspect, the network-based graphical communication system may include a client-side computing device operable to run a client-side application. The client-side application may include multiple digital images or icons, of various embodiments, that can convey ideas and opinions pertaining to specific qualities, attributes, or characteristics of subject matter, along with a search field operable to receive text and graphical input, a search results area, a tagging selection area, a rating selector, and location detection service. The network-based graphical communication system may also include an administrative server that includes a profiling engine configured to generate one or more of subject matter profiles, user profiles, or audience profiles. The administrative server may also include a satisfiability rating engine.

### CROSS-REFERENCE TO RELATED APPLICATIONS

This present application is a continuation-in-part of non-provisional patent application Ser. No. 14/752,910, filed on Jun. 27, 2015, which claimed priority to provisional patent application 62/018,647, filed on Jun. 29, 2014. This patent application also claims the benefit of the priority of provisional patent application 62/018,647, filed on Feb. 5, 2016. Each of the non-provisional patent application Ser. No. 14/752,910, the provisional patent application 62/018,647, and the provisional patent application 62/018,647 are hereby incorporated by reference in their entirety.

### COPYRIGHT

A portion of the disclosure of this patent document contains or may contain material subject to copyright protection. The copyright owner has no objection to the photocopy reproduction of the patent document or the patent disclosure in exactly the form it appears in the Patent and Trademark Office patent file or records, but otherwise reserves all copyright rights.

### FIELD OF TECHNOLOGY

The technology of the present application relates generally to social proof systems and in particular to providing a network-based graphical communication system for sharing and aggregating opinions and reviews.

### BACKGROUND

Social proof has historically been one factor in decision making. Online reviews, opinions, and user experience based ratings, for example, have provided guidance for making informed decisions.

Typically, online opinions have been expressed in lengthy text based content, nonspecific and non-unified rating systems, such as overall star ratings and other non-descript and vague rating systems, or some combination. This can result in users spending a time reading and writing reviews, watering down specific concepts and opinions of good and bad features or ideas into nonspecific consolidated units of measurement, such as overall star ratings, that fail to express unique opinion of the various attributes of the subject matter, or both. This has tended to result in tradeoffs being made between time consuming, annoying, non-standardized data collection that involves complex post processing and translation of natural language entry, and over-simplified, content-poor, biased, approaches that rely on ambiguous suggestions of subjective emotion, such as a thumbs up icon, a smiley face, or the like.

On occasion, surveys have been used to collect specific data points, but these tend to be unpopular with users not wanting to invest the time to answer multiple questions, resulting in their either or not participating, not thinking through the responses, or abandoning the survey entirely. Additionally, survey questions often injected importance to attributes that would have otherwise been un-noteworthy to the individual taking the survey. This sort of bias tended to reduce the value, accuracy, and usefulness of survey results.

In the case of unstructured data, such as those in the form of written reviews, providing effective search interfaces and result sets has been difficult, as specific concepts and opinions are ambiguously and inconsistently suggested within the unstructured data, and associated with specifics unrelated to the subject matter of interest. Further, user reviews, opinions, ideas, and the like regarding the subject matter of interest have been typically scattered across different pages, different web sites, or both, contributing to challenges in generating aggregated content reflecting a consistent review, opinion, idea, or concept.

As a result, it has been difficult to create subject profiles that could help to provide insights into the users and marketers regarding their strengths and weaknesses relating to a given subject matter. An additional resulting challenge has been the difficulty in using the standard user-based or customer-based feedback to create audience profiles for use within, for example, a marketing system. Extracting the specific sentiment from unstructured data found in written reviews and overall ratings has been difficult, inefficient, err-prone, because, at least in part, this approach typically involves ambiguous language that is hard to quantify, and often relies on natural language, local idioms, and the parlance of a particular time or place to capture the subjective opinions and ideas of individuals.

In addition, the use certain of these approaches, such capturing, storing, transmitting, aggregating, processing, and reporting on this unstructured data has placed memory, processing, and bandwidth demands on the computing architectures and devices of the system. This, in turn, has often resulted in one or more of increased complexity, increased costs, and increased hardware or instances deployment and management. Further, the evolving and disparate nature of language generally has led to an increasing and ongoing need to consider the language specifics, and manage those specifics through complex and expensive artificial technologies such as natural language processing. These difficulties have been exacerbated when aggregating across geographies and cultures.

### BRIEF SUMMARY OF SOME ASPECTS OF THE DISCLOSURE

The applicants believe they have discovered at least one or more of the problems and issues with systems noted above as well as advantages variously provided by differing embodiments of the network-based graphical communication system disclosed in this specification. Briefly and in general terms, a network-based graphical communication system for sharing and aggregating opinions and reviews is described. The network-based graphical communication system can include, among other things, one or more mobile devices, a web interface, such as a hosted web site, and digital images, icons, or both.

In some embodiments, the network-based graphical communication system disclosed allows users to quickly, and graphically, share opinions and reviews regarding products, services, persons, places, things, activities, concepts, and the like. The network-based graphical communication system includes hardware, software, hosted services, user interfaces, back-end database systems, and an administrative system, one or more of which can transmit data, receive data, or both over a network, such as the Internet. In one embodiment, the user interface includes a native mobile application, such as an iOS app, a website, or both. These user interfaces can make use of one or more software development kits, popularly known as “SDK” s, that may provide one or more properties, methods, functions and other tools to communicate over a network with third-party database systems and data providers such as Parse™ and Factual™.

It will be appreciated by one skilled in the art that other embodiments of user interfaces can be used with the network-based graphical communication system, including mobile applications for other mobile device operating systems, smart watch applications, browser based plugins, application programming interfaces for integrating a graphical icon-based rating system into other websites and applications, and other user device embodiments. It will be appreciated by one skilled in the art that other embodiments of the network-based graphical communication system could make use of other backend database systems and data providers, and that this system can be deployed using networks other than the Internet.

In some embodiments, a digital image or icon, such as, for example, an emoji icon, graphically represents an opinion or perspective, such as a specific opinion or perspective, relating to, for example, one or more products, services, businesses, persons, places, things, concepts, or activities, that can be tagged to content, such as Internet-based content. For purposes of this disclosure, unless otherwise clear from the context of the usage, when used as a noun, “Likemoji” refers to the proprietary digital image and icons, including emojis, of Likemoji corporation. These Likemojis can be digital images or icons, such as, for example, glyphs, of various embodiments, and can convey ideas and opinions pertaining to specific qualities, attributes, or characteristics. For example, a Likemoji could represent ideas such as (but not limited to) “great coffee”, “fast shipping”, “poor battery life”, “great views”, “family friendly dining”, “bad customer service”, “great design”, “high cost”, “great value”, and so forth. Likemojis can allow users to obtain a sense for specific community opinion of various subject matter with a quick glance. The nature and use of Likemojis can simplify the process, increase the speed, or both, for the user when providing ideas and opinions, thus increasing participation and the resulting value and accuracy of user-generated opinions and perspectives. The use of Likemojis, as compared to freeform text entry and surveys, can reduce bandwidth use, processor cycles resulting from processing natural language text, and memory usage.

Unless otherwise clear from the context of the usage, when used as an adjective, “Likemoji” refers to the Likemoji corporation or the proprietary network-based graphical communication system developed and operated by the Likemoji corporation.

In some embodiments, Likemojis can be represented as an attribute with a rating or adjective integrated into the digital image or icon. In some instances, the integrated rating, adjective, or both are dynamically associated and integrated with the digital image or icon. In other instances, the integrated rating, adjective, or both are a static element of the digital image or icon. In some embodiments, the rating, adjective, or modifier are proximal to the digital image or icon. In other embodiments, Likemojis can be represented with a neutral graphical representation of the attribute combined with one or more of a numeric rating, a grade displayed as, for example, a badge, or a modifier near the icon. In these embodiments, users can communicate and convey specific sentiment in relation to specific attributes with a uniquely descriptive and structured visual taxonomy. This can help to increase specificity and applicability to particular subject matter, making it easier to aggregate within a domain and across dispersed content given the uniform data structure, improve the value of aggregated user input, and help to resolve regional, cultural, and language difference across the user community.

In some implementations, Likemojis can be one or more of created, edited, and deleted using, for example, an administrative interface served from an administrative service or server. The icons can be stored, for example, in the Parse Core™ backend system as Likemoji PFobjects (507b) and are available for use within the network-based graphical communication system using functionality and tools provided by the Parse SDK (software development kit).

In some instances, Likemojis are displayed on user computing devices via mobile applications, websites, or both, and can represent the aggregated consensus of one or more of opinions, perspectives, ideas, concepts or ratings tagged by previous users of the network based graphical communication system. Likemjois can also provide tagging functionality for sharing opinions or ratings of given subject matter viewed from the mobile application, website, or both.

In some embodiments, the data generated by mobile device or website Likemoji tagging activity is stored in the Parse back-end database system and can be provided to business side customers through a web-portal. Analytics, subject and audience profiles, user engagement campaigns, targeted marketing campaigns, and other benefits can be used to leverage the valuable user contributed data captured by the network-based graphical communication system.

In some embodiments, a mobile application that runs on one or more mobile devices is a mobile solution for tagging Likemojis to, for example, one or more of, a place, such as a restaurant, store, any other kind of business, or location, products, or other content, such as internet or network based content, using a smartphone or mobile device. Mobile application users can quickly share one or more of feedback, opinions, ratings, and reviews regarding specific qualities of things by selecting the icon, corresponding rating, or both that expresses their unique view or experience.

In addition to tagging, in some embodiments, users can search for places, products, services, and other types of businesses, as well as other content, by entering a combination of words, Likemojis, or both into the search field. The mobile application can provide results of relevant content based on the prevalence of matching Likemojis that have been previously tagged to relevant content using one of the various embodiments of a client side interface integrated with the network-based graphical communication system.

In some embodiments, a website offers content tagging, search functionality, or both using Likemojis. In some instances, users of the website have the ability to find content on the internet by searching for content that has been previously tagged with Likemojis. Users can browse and tag specific subject matter of interest with Likemojis, such as for ratings. Additionally, in some applications, users of the website have access to analytics based on structured data that has been generated by the internet user community's use of the network-based graphical communication system.

In some embodiments, data collected within the network-based graphical communication system is used by a profiling engine to create detailed profiles of one or more of products, services, businesses, places, activities, and other subject matter based on crowd sourced aggregated user sentiment. Specific strengths, weaknesses, and other attributes relating to the subject become clear as defined by the crowd and can be used for business analysis, marketing, strategy and other means.

In some embodiments, data collected within the network-based graphical communication system can be used by the profiling engine to create detailed profiles of the users, the audience, or both, of a given subject. User-based preferences and habits can contribute to user profile metrics that can be used for targeted marketing campaigns and user or customer engagement activities and interactions.

In some implementations, a satisfiability rating engine uses the ratings and opinions contributed by a user and compares them to the average ratings and opinions contributed by fellow users for the same subjects. The difference between the unique user's ratings and that of the user's peers or fellow users is used to establish a unique “satisfiability rating” for the particular user. Profiling audiences based on their unique satisfiability ratings can aid in providing content that is more relevant to a particular user type or group of users, and can also be leveraged for highly targeted, user type, group specific marketing campaigns. Additional detail and features regarding user satisfiability ratings will be provided as this specification proceeds.

The foregoing has outlined rather broadly the features and technical advantages of examples. The conception and specific examples disclosed may be readily utilized as a basis for modifying or designing other structures for carrying out the same purposes of the present disclosure. Features which are believed to be characteristic of the concepts disclosed herein, both as to their organization and method of operation, together with associated advantages will be better understood when considered in connection with the accompanying figures and as this specification proceeds. Each of the figures is provided for the purpose of illustration and description only, and not as a definition of the limits of the claims included herein now or as amended during prosecution.

### BRIEF DESCRIPTION OF THE DRAWINGS

A further understanding of the nature and advantages of the embodiments may be realized by reference to the following drawings.

FIG. 1A is a block diagram of an environment in which the present systems and methods may be implemented;

FIG. 1B is a block diagram of a system architecture schematic of the network-based graphical communication system that can be implemented in the environment of FIG. 1A;

FIG. 2 is a block diagram of mobile devices in communication with the backend infrastructure of the network-based graphical communication system of FIG. 1B;

FIG. 3 is a block diagram of a project architecture for the mobile devices of FIG. 1A, FIG. 1B, and FIG. 2;

FIG. 4A is a block diagram of the application structures of some of the project elements of the project architecture of FIG. 3;

FIG. 4B is a block diagram of another breakdown of the application structures of some of the project elements of the project architecture of FIG. 3;

FIG. 5A is a block diagram of one embodiment of the User, Activity, Photo, and User tag Parse Class Data Structures stored within the Parse Core Backend of the backend infrastructure of FIG. 1B;

FIG. 5B is a block diagram of one embodiment of the Location Tags, Location Ratings, Likemoji, and Check In Parse Class Data Structures stored within the Parse Core Backend of the backend infrastructure of FIG. 1B;

FIG. 6 is a flow diagram of a method creating a new mobile user account in the network-based graphical communication system of FIG. 1B;

FIG. 7 is a flowchart of a method retrieving a user's location via mobile device or specified location of interest in the network-based graphical communication system of FIG. B;

FIG. 8 is a block diagram of some of the administrative element of the network-based graphical communication system of FIG. 1B;

FIG. 9 is a flowchart of a method for querying data from the Factual and Parse frameworks of FIG. 4B;

FIG. 10 is a flowchart of a method of basic mobile user interactions for tagging Likemoji icons to a location, checking-in to a location, and submitting photos of a location to the network-based graphical communication system of FIG. 1B;

FIG. 11 is a representation of Likemoji icons displayed on a mobile device of FIG. 1A, FIG. 1B, and FIG. 2 along with the corresponding data and associated ratings saved to the Parse Core;

FIG. 12A is a flowchart outlining the auto-complete search process when querying the Factual Places API or similar location based data service provider as part of the of the network-based graphical communication system of FIG. 1B;

FIG. 12B is a flowchart of the auto-complete search process when querying the Factual Places API or similar location based data service provider of FIG. 12A combined with a filter as part of the network-based graphical communication system of FIG. 1B;

FIG. 13 is a flowchart of the icon-based search process of the network-based graphical communication system of FIG. 1B;

FIG. 14 is a screen capture of an exemplary user interface for a mobile device displaying locations and associated top-tagged emoji ratings associated with those locations in response to a location detection event;

FIG. 15 is a screen capture of an exemplary user interface for a mobile device search using emoji icons on a mobile device of FIG. 1A, FIG. 1B, and FIG. 2;

FIG. 16 is a screen capture of an exemplary user interface for a mobile device presenting search results in response to submission of an icon-based search request using the icon-based search interface of FIG. 15;

FIG. 17 is a screen capture of an exemplary user interface for a mobile device presenting the highest ranking search results for selected attributes in response to submission of a map display request using the search results interface of FIG. 16;

FIG. 18 is a screen capture of an exemplary user interface for a mobile device presenting a detailed item view in response to an item selection event using the search results interface of FIG. 16;

FIG. 19 is a screen capture of an exemplary user interface for a mobile device presenting a detailed item subview in response to detection of a selection event of the detail item view interface of FIG. 18;

FIG. 20A is a screen capture of an exemplary user interface for a mobile device presenting a tag selection interface on a mobile device of FIG. 1A, FIG. 1B, and FIG. 2;

FIG. 20B is a screen capture of an exemplary user interface for a mobile device presenting a tag selection interface on a mobile device of FIG. 1A, FIG. 1B, and FIG. 2;

FIG. 21A is a screen capture of an exemplary user interface displaying a Likemoji graphical object for use with the network-based graphical communication environment of FIG. 1;

FIG. 21B is a screen capture of an exemplary user interface displaying another Likemoji graphical object for use with the network-based graphical communication environment of FIG. 1;

FIG. 21C is a screen capture of an exemplary user interface displaying another Likemoji graphical object for use with the network-based graphical communication environment of FIG. 1;

FIG. 21D is a screen capture of an exemplary user interface displaying another Likemoji graphical object for use with the network-based graphical communication environment of FIG. 1; and

FIG. 22 is a block diagram of a computer system suitable for implementing the various technologies of the present system and methods in the environment of FIG. 1.

### DETAILED DESCRIPTION OF THE PREFERRED AND OTHER EMBODIMENTS

Broadly, this disclosure is directed towards a network-based graphical communication system for sharing and aggregating opinions and reviews. The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods and processes described may be performed in an order different from that described, and various steps may be added, omitted, or combined. Also, features described with respect to certain embodiments may be combined in other embodiments.

Certain embodiments of the invention are described with reference to methods, apparatus (systems) and computer program products that can be implemented by computer program instructions. These computer program instructions can be provided to a processor of one or more of a special purpose computer or other programmable data processing apparatus to produce a machine, such that the instructions, which execute via the processor of the computer or other programmable data processing apparatus, create means for implementing the acts specified herein to transform data from a first state to a second state.

These computer program instructions can be stored in a computer-readable memory that can direct a programmable data processing apparatus to operate in a particular manner, such that the instructions stored in the computer-readable memory produce an article of manufacture including instruction means which implement the acts specified herein. The computer program instructions may also be loaded onto a programmable data processing apparatus to cause a series of operational steps to be performed on the programmable apparatus to produce a computer implemented process such that the instructions which execute on the computer or other programmable apparatus provide steps for implementing the acts specified herein.

The various illustrative logical blocks, modules, and algorithm steps described in connection with the embodiments disclosed herein can be implemented as electronic hardware, computer software, computing device firmware, or some combinations thereof. To clearly illustrate this interchangeability of hardware, software, and firmware, various illustrative components, blocks, modules, and steps have been described generally in terms of their functionality. Whether such functionality is implemented as hardware, software, or firmware depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed with a processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. The processor can be, for example, a microprocessor, processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The blocks of the methods and algorithms described in connection with the embodiments disclosed herein can be embodied directly in hardware, in a software or firmware module executed by a processor, or in a combination of the two. A software or firmware module can reside in RAM memory, flash memory, ROM memory, EPROM memory, EEPROM memory, registers, a hard disk, a removable disk, a CD-ROM, or any other form of computer-readable storage medium known in the art. An exemplary storage medium is coupled to a processor such that the processor can read information from, and write information to, the storage medium. In the alternative, the storage medium can be integral to the processor. The processor and the storage medium can reside in an ASIC. In the alternative, the processor and the storage medium can be discreet components.

Depending on the embodiment, certain acts, events, or functions of any of the methods described herein can be performed in a different sequence, can be added, merged, or left out all together (e.g., not all described acts or events are necessary for the practice of the method). Moreover, in certain embodiments, acts or events can be performed concurrently, e.g., through multi-threaded processing, interrupt processing, or multiple processors or processor cores, rather than sequentially. Moreover, in certain embodiments, acts or events can be performed on alternate tiers within the architecture.

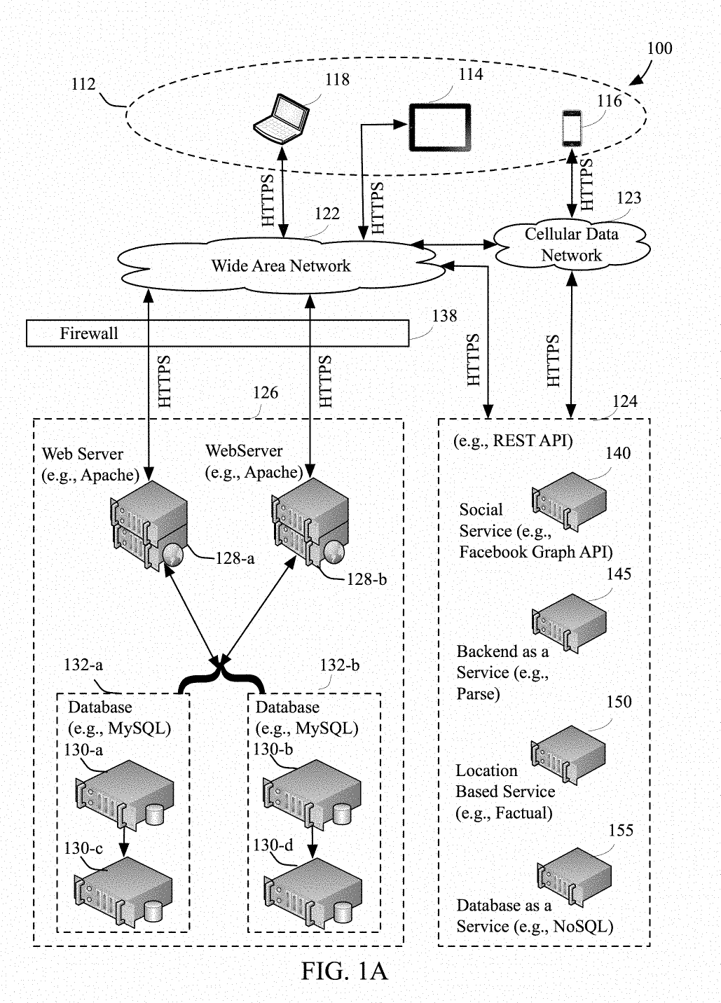

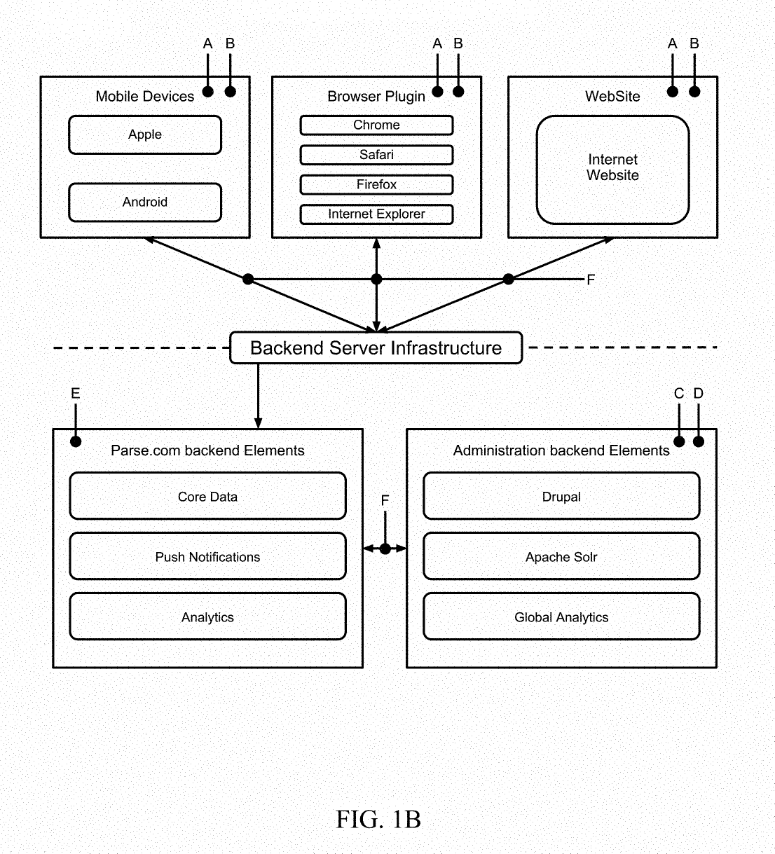

Referring now to FIG. 1A, the systems and methods disclosed can be implemented in a digital processing environment 100. The present systems and methods can also run on different architectures that may include a LAN, WAN, stand-alone PC, stand-alone mobile device, a stand-alone, clustered, or networked mini or mainframe computers, wearables, etc.

FIG. 1A is only an example, however, as many other computing arrangements can support the systems and methods disclosed in this specification. Further, the system shown in FIG. 1A can utilize a wide variety of differing sub-systems in order to support the disclosed systems and methods.

For example, in one embodiment, the implementation of the network-based graphical communication system runs in the Linux® environment. In another embodiment, the software is implemented to run in other environments, such as Windows®, UNIX °, and may run on any hardware having enough power to support timely operation of software such as that identified in FIG. 1A. In certain instances, computers are deployed as virtual instances rather than physical computers, and in certain cases, in an elastic computing environment such as Amazon Web Services®.

In some deployments, web servers 128 are instances of Apache® with one or more packages or frameworks deployed, such as, for example Apache Solr®. Those skilled in the art will appreciate that other web server, application server technologies, and frameworks can be used as an alternative to Apache® and Apache Solr®. Web servers 128 can communicate with one another, and with client devices and instances, over, for example, HTTPS. Other protocols may be used depending on the technology stack deployed. The web servers can communicate with the database instances 132 via, for example. the transmission of BSON (Binary JavaScript Object Notation) objects using a PHP driver object designed to specifically facilitate database interactions, such as database reads and writes.

Database servers 132, in some embodiments, can deploy a relational databases with traditional schema restrictions such as Microsoft SQLServer®, MySQL®, and SQLLite®. Alternatively, schemaless non-relational, NoSQL databases, such as MongoDB, can be deployed, storing information as documents rather than as records in tables. In certain implementations, the database deployment can be implemented in a sharded cluster 132. The shards 132 store the data, providing high availability and data consistency, with each shard 132 including a replica data set 132-c, 132-d. The replica sets 132-c, 132-d are a group of database instances that host the same data set. One database instance for each of the primaries 130-a, 130-b receives all write operations. All other instances, secondaries 130-c, 130-d, apply operations from the primary so that they have the same data set. The primaries 130-a, 130-b accept all write operations from clients.

In certain implementations, the web servers 128 interface with one or more cloud services 124, such as, for example, social services 140 such as Facebook® Graph API, backend as a service solutions such as Parse®, location based services such as Factual®, and one or more database as a service platforms, over a REST API using, for example, JSON objects. In some instances, one or more cloud services are third party services with associated fees.

Computing devices of various types 112 can connect to a remote server infrastructure 126 via a network 122, 123 over a communication protocol, such as, for example, TCP/IP. One or more computing devices can pass information as one or more of unstructured data, structured files, structured data streams such as, for example, XML, structured data objects, and/or structured messages. Client computing devices 118, 114, 116 may communicate over various protocols such as, for example, UDP, TCP/IP, and/or HTTPS.

Client computing devices 118, 114, 116 and server computers 126, 124 provide processing, storage, and input/output devices executing logic instructions. Client computers 112 can also be linked through communications network 122 to other computing devices, including other client devices/processes 112 and server computers 126, 124.

In some embodiments, server computers 126 run software to implement centralized persistent data storage and retrieval. The network 122 can be a wide area network that is part of a remote access network, a global network (e.g., the Internet), a worldwide collection of computers, gateways that currently use respective protocols (TCP/IP, UDP, etc.) to communicate with one another, and the like.

Referring now to FIG. 1B, in some embodiments, the front end clients communicate over a wireless or wired network with the backend as a service solution such as the Parse platform. The backend as a service platform can perform one or more of hosting data, processing push notifications, and providing analytic services and output. Administrative backend elements such as, for example, Drupal®, Apache® Solr, and Global Analytics can be used to perform or support one more of creating, editing, appending, and manipulating data stored in the Parse backend platform. Other embodiments of the network-based graphical communication system can utilize other backend database and administrative systems instead of the backend as a service Parse platform.

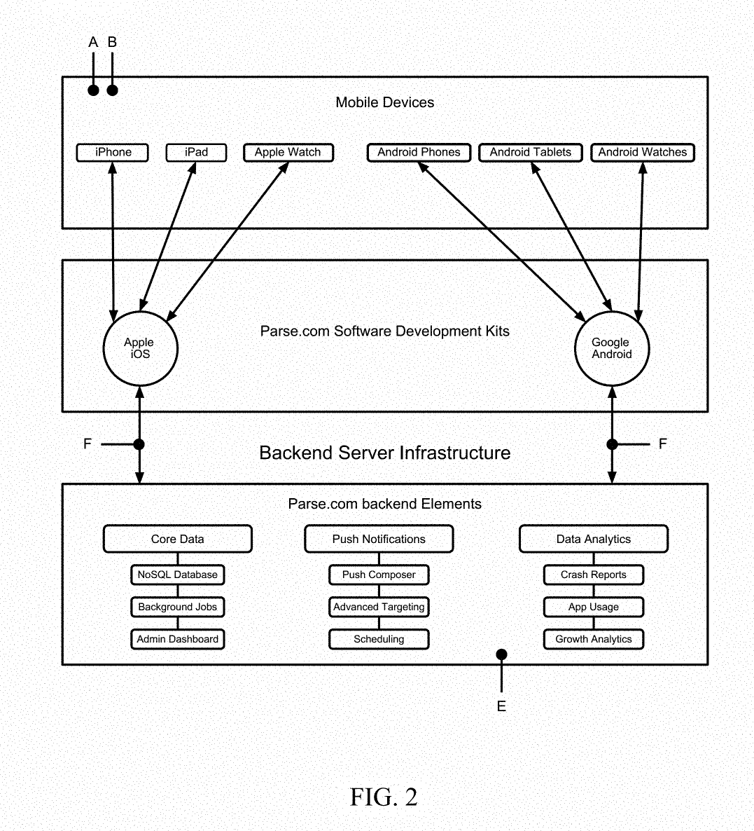

Referring now to FIG. 2, in some implementations, various mobile clients utilize Parse.com software development kits for Apple iOS, Google Android, and the like. Data collected from the mobile clients is transmitted to the Parse backend or similar backend as a service platform over the network. The data received by the backend as a service platform is then stored in a database, such as the NoSQL database hosted by Parse. The data can then be processed with a background job system, cloud code, or both. Data can be edited using, for example, the Parse.com administrative dashboard. The processed data and other data can be transmitted back through the network to the mobile client utilizing the backend as a service software development kit functionality, such as the Parse software development kit, and displayed on the mobile client.

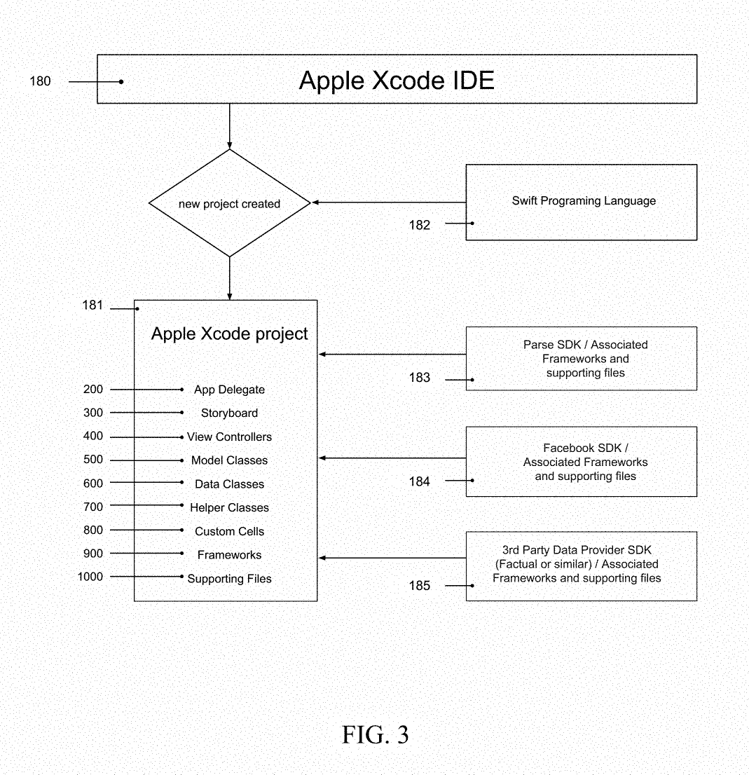

Referring now to FIG. 3, an example client-side mobile application for iOS is described, created and set up using Apple's Xcode IDE. In some embodiments, the Swift programming language is used, and software development kits, frameworks, view controllers, model classes, data classes, helper classes and other elements are created or added for use by the application.

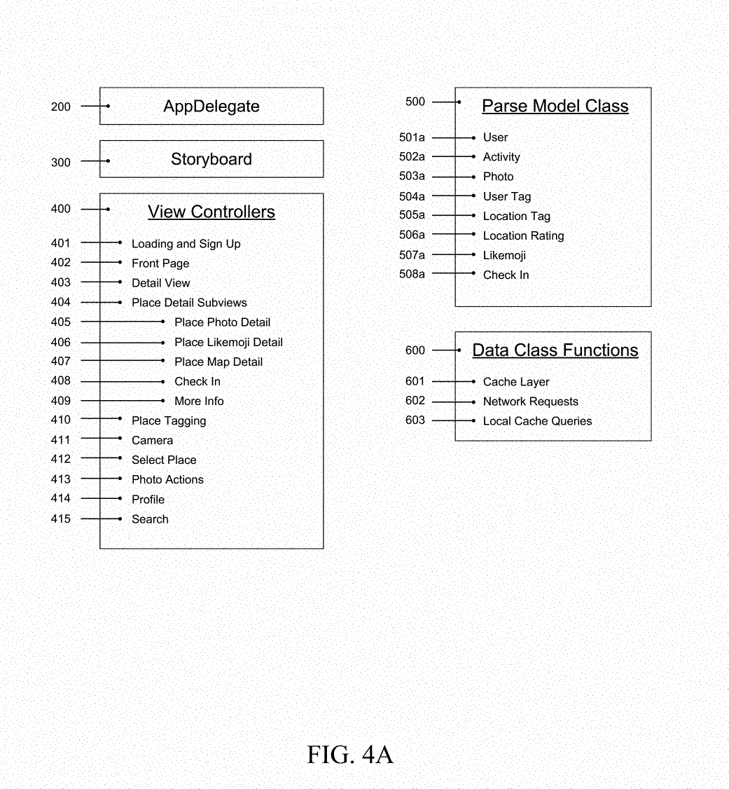

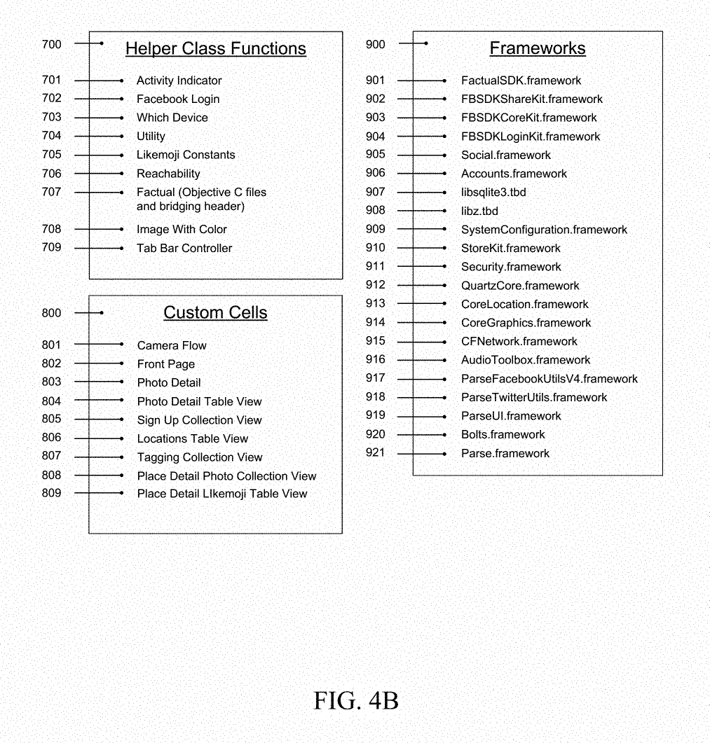

Referring now to FIG. 4A and FIG. 4B, in some embodiments, Apple Xcode project elements are described at a high level.

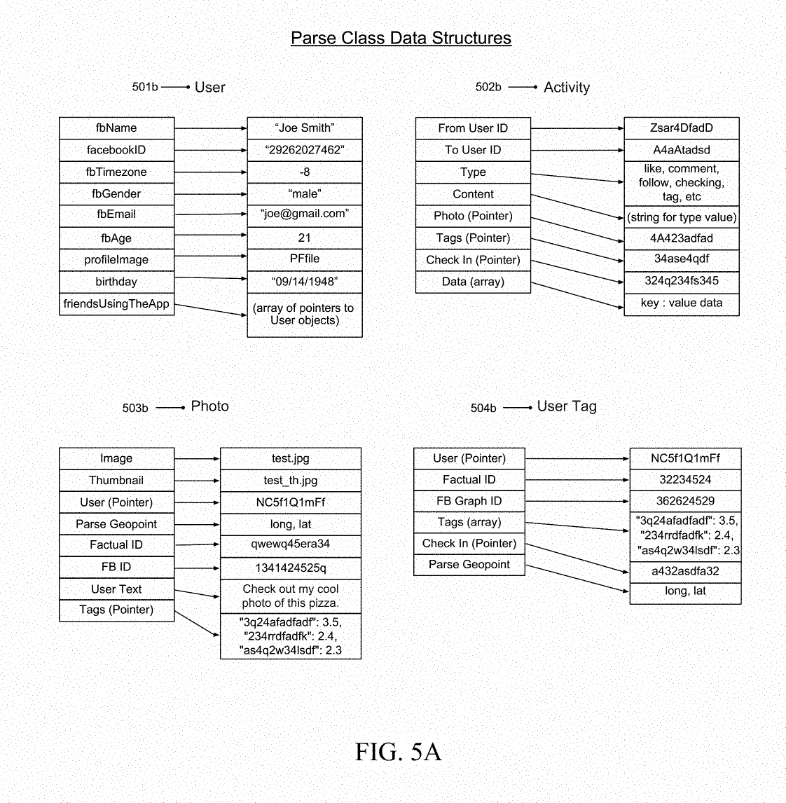

Referring now to FIG. 5A in some instances, the User, Activity, Photo, and User tag Parse Class Data Structures are stored within a Parse Core Backend.

Referring now to FIG. 5B, in certain instances, the Location Tags, Location Ratings, Likemoji, and Check In Parse Class Data Structures are stored within a Parse Core Backend.

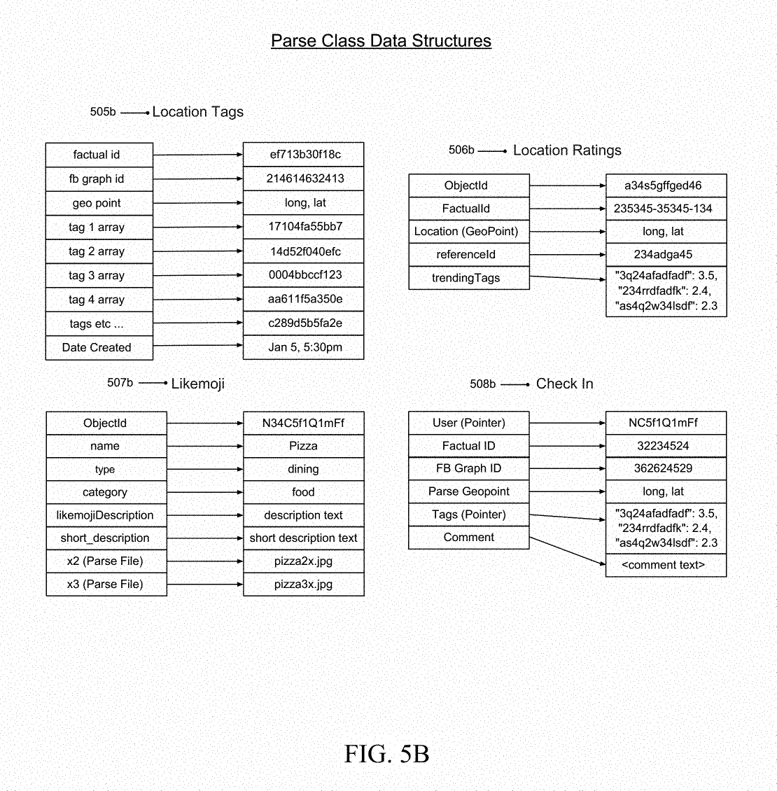

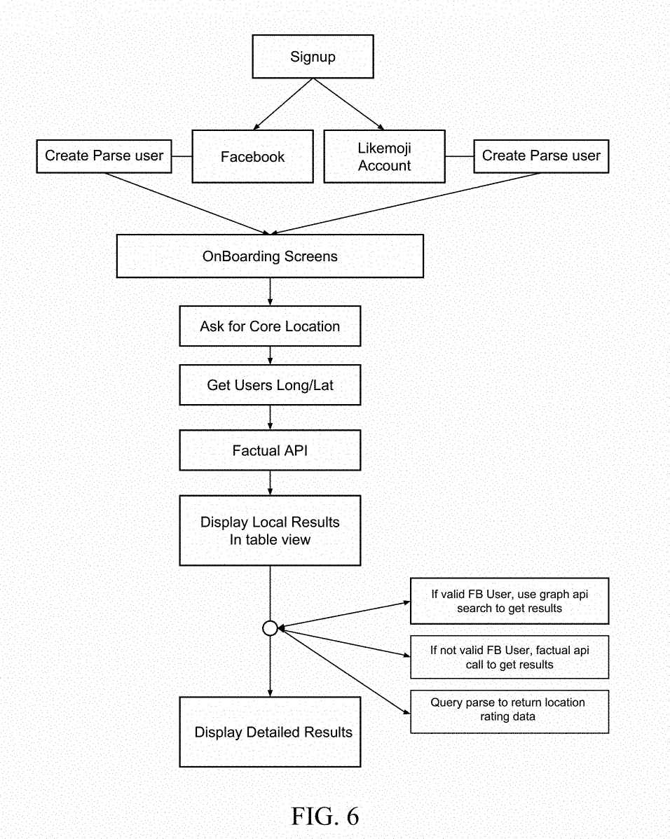

Referring now to FIG. 6, in some embodiments, the process of creating a new mobile user account includes creation of a parse user object upon signup either by the new user signing up via email, or, in some instances, the Facebook login SDK. After the parse user object has been created, the user is asked to enable Core Location allowing the application to capture the user's location coordinates. Using the Factual API or a similar location data service provider, the application can then display local results. The displayed detailed location results can be paired with additional data from, for example, the Facebook Graph API along with Likemoji data from the Parse backend.

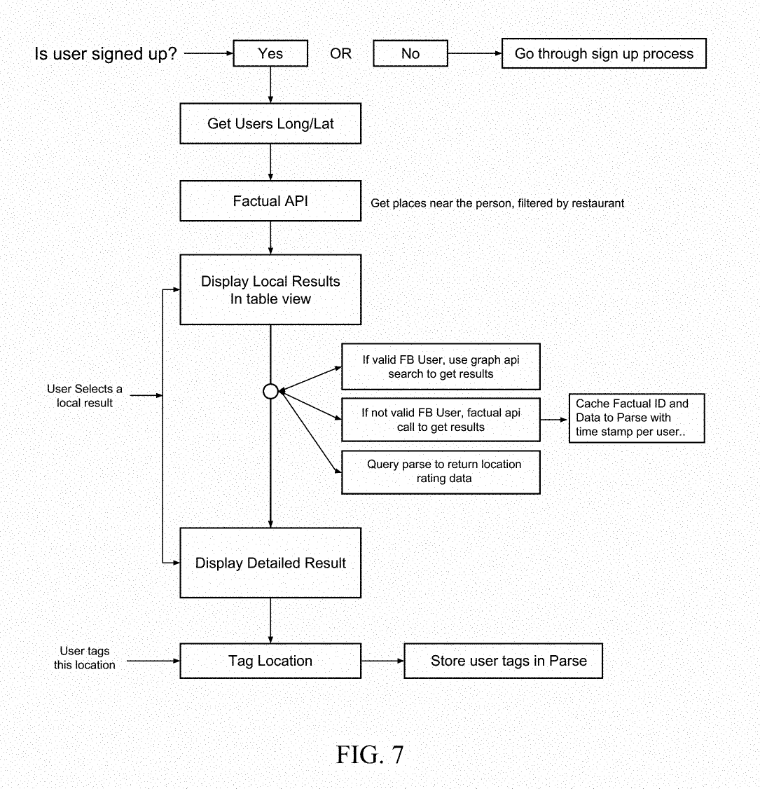

Referring now to FIG. 7, in some embodiments, the network-based graphical communication system includes a process of retrieving a user's location via mobile device or specified location of interest, pulling data from the Factual API or similar location based data provider. The relevant location data from Factual is then paired with additional data and images from, for example, the Facebook Graph API and Likemoji data queried from the Parse backend. One or more of detailed location information, photos, and Likemoji ratings are then displayed to the user. Users can then contribute their own Likemoji ratings and tags which are stored and aggregated within the Parse backend.

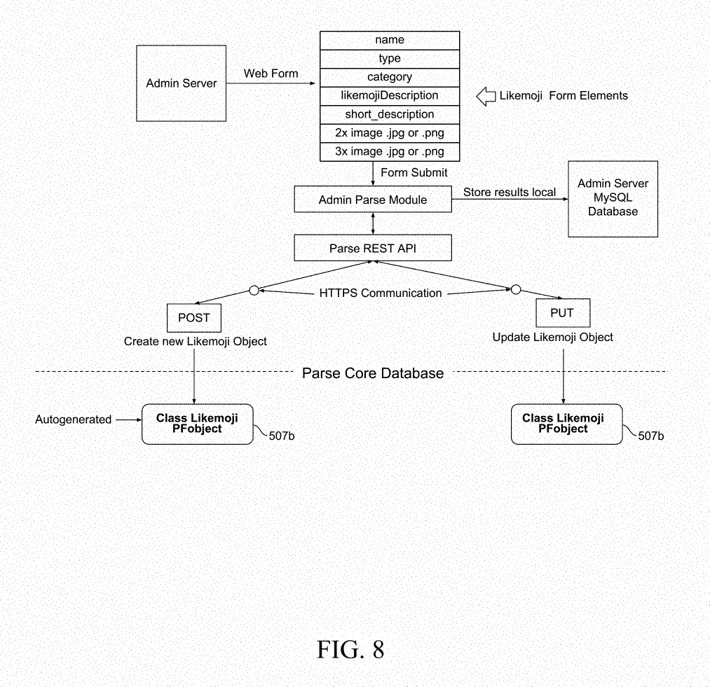

Referring now to FIG. 8, in some implementations, an administrative element of the network-based graphical communication system performs creation of new Likemoji objects to be stored on the Parse Backend. An administrative server can host a web form containing form elements that define the various Likemoji icons being contributed to the system. Upon submittal of the Likemoji icon web form elements, the data can be processed by the Admin Parse Module and sent to the Parse REST API. In some implementations, the Parse REST API then uses HTTPS communication to Post (create) new Likemoji PFObjects (Parse objects) and to Put (edit) existing Likemoji PFObjects (Parse objects) and store them in the Parse Core Database. In other embodiments, the Parse Core Database and Parse supported functions and processes could be replaced by a more traditional backend system such as a combination of load balancers, servers and databases.

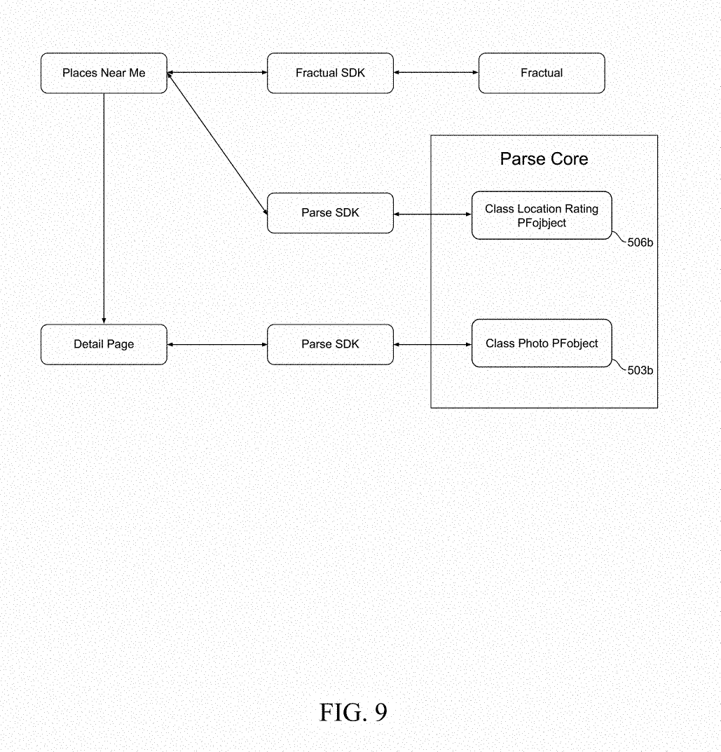

Referring now to FIG. 9, in certain embodiments, data queried from Factual and Parse is displayed to the client-side user. The pertinent Class Location Rating PFobject and Class Photo PFobjects associated with a given subject (in this case, specific Factual location IDs) are queried using Parse SDK functionality and returned to the client from the Parse Core.

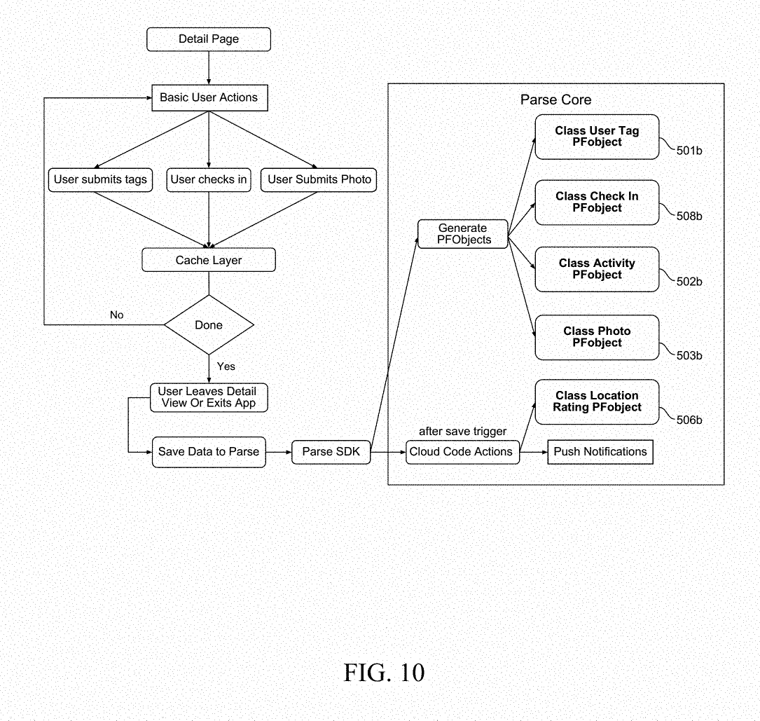

Referring now to FIG. 10, in some instances, basic mobile user interactions for tagging Likemoji icons to a location, checking-in to a location, submitting photos of a location, and the like, are available. User input can be stored in the Cache Layer on the mobile device. Once as user has completed interacting with the detail page and leaves the page or exits the application, the Cache Layer data can be saved to the Parse Core using Parse SDK functionality. When saving data to the Parse Core, in some cases, client-side Parse model classes 500 (e.g., see FIG. 4A) are referenced and Parse SDK functionality is used to transmit and store data to the Parse Core as PFobjects with the data structures as described in FIG. 5A and FIG. 5B. Further processing of Likemoji user tags including aggregating tag data is completed as a Parse Cloud Code Action and used to create Location Rating PFobjects (506b) which are also stored in the Parse Backend. Upon completion of Parse Cloud Code Actions, push notifications and other actions can be triggered.

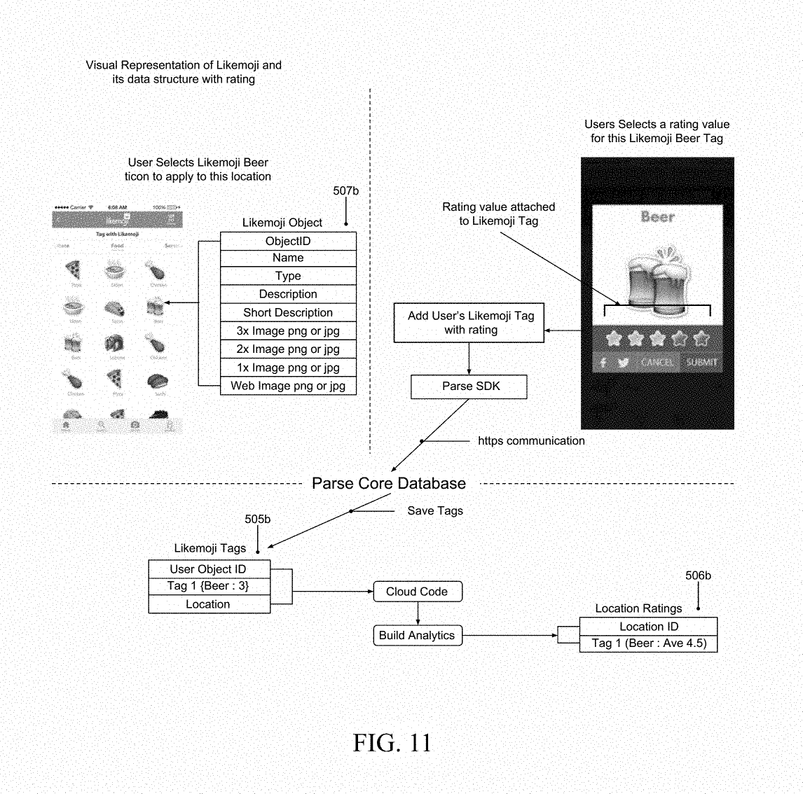

Referring now to FIG. 11, in certain implementations, Likemoji icons are displayed on a mobile device and the corresponding data and associated rating are saved to the Parse Core using Parse SDK functionality. When a Likemoji rating is submitted to the underlying subject matter, the Likemoji object is sent by the Parse Mobile SDK via, for example, https communication to the Parse Core Database where the Data is saved as a unique record. The Location Tags and corresponding rating PFobjects (505b) associated with a given Factual location ID are compiled using cloud code actions and Location Rating PFobjects (506b) are created and stored in the Parse Core.

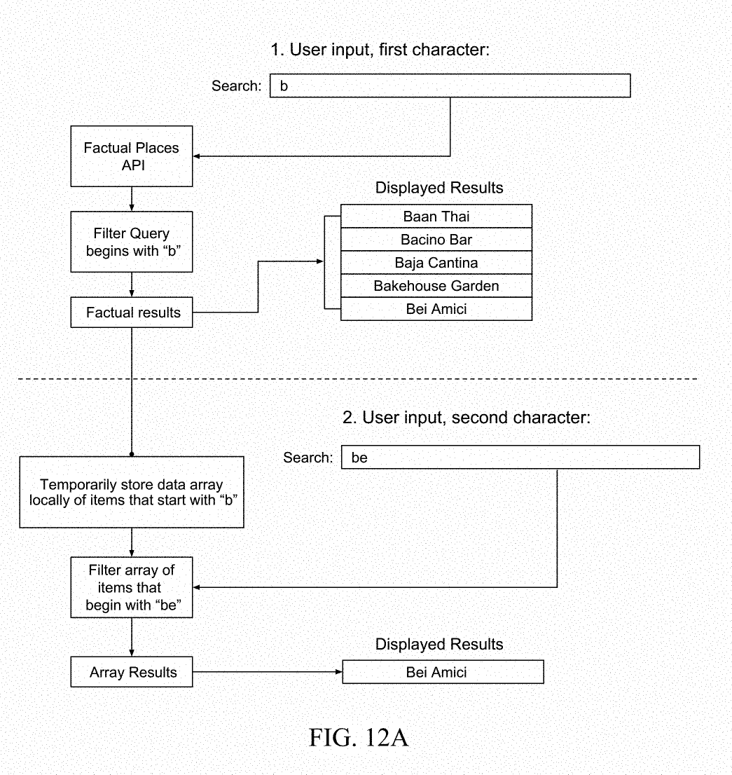

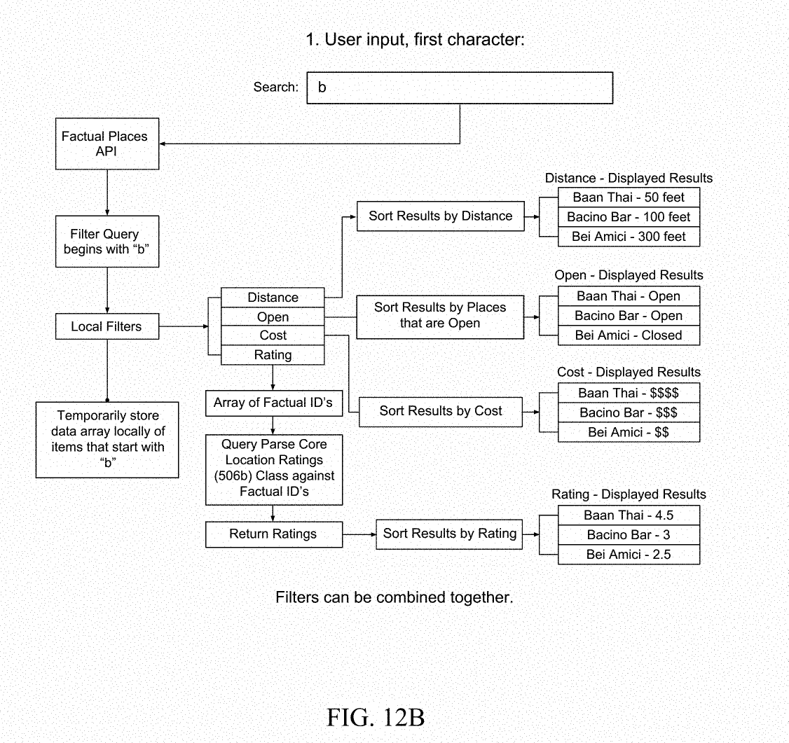

Referring now to FIG. 12A, in some embodiments an auto-complete search process executes when querying the Factual Places API or similar location based data service provider. When the first character of a query is entered by the user, query results are returned from the Factual API and displayed to the user while also being temporarily stored in a local data array within the client side cache layer. The temporarily stored data results array can then be further filtered upon the user entering a second character.

Referring now to FIG. 12A, in some embodiments an auto-complete search process executes querying the Factual Places API or similar location based data service provider combined with a filter. When the first character of a query is entered by the user, query results are returned from the Factual API and filtered by any combination of local filters. Results are sorted by a combination of filtered data. In the case of a rating based filter, for example, the array of Factual location IDs can be used to query the Parse Core database for Location Rating PFobjects (506b) which returns results filtered by ratings stored in the Parse backend. The results are displayed to the user while also, in some cases, being temporarily stored in a local data array within the client side cache layer. The temporarily stored data results array can then be further filtered upon the user entering a second character.

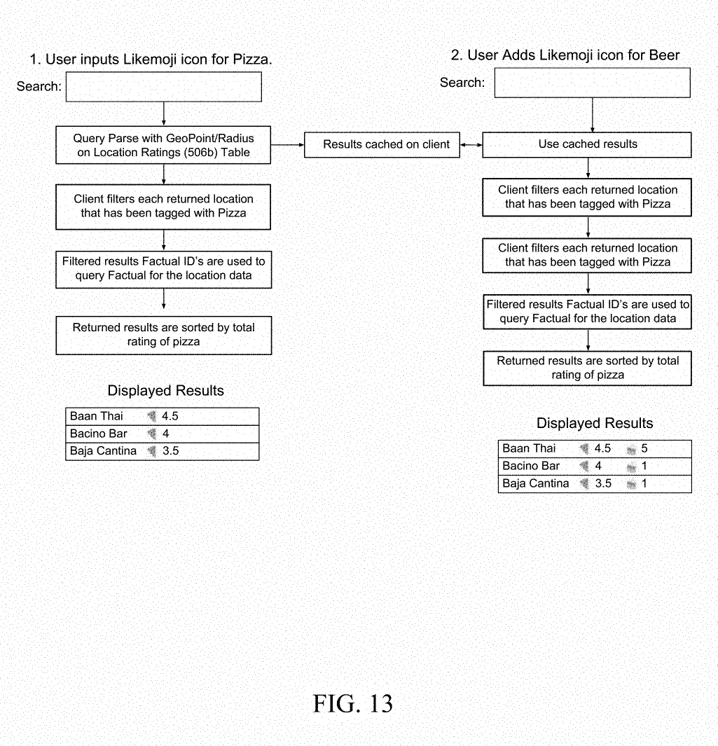

Referring now to FIG. 13, in some implementations, logic is used when conducting an Likemoji Icon based search. The Likemoji Icon input occurs representing the attribute of interest and a query is sent to the Parse Backend. Location Rating PFobjects (506b) that match the user query are paired with data provided by, for example, a third-party data provider, such as Factual location data, and returned to the client device and ordered by the rating value associated with the Likemoji Icon or Icons used in the search. The ordered data is then displayed on the client device and the user is presented with results based on aggregated Likemoji ratings that have been previously contributed to the network-based graphical communication system.

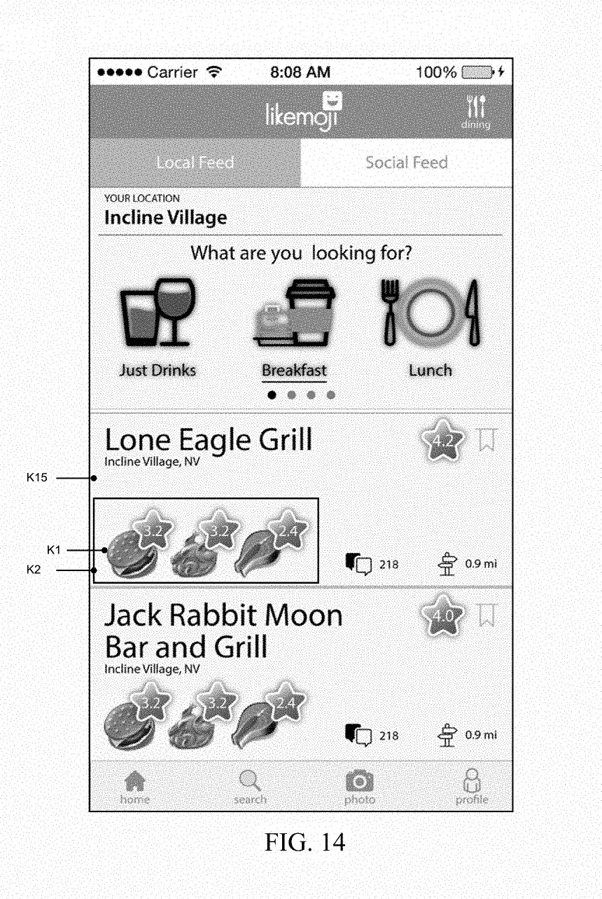

Referring now to FIG. 14, in some embodiments of the Mobile Application, locations around the client-side user are presented along with the top-tagged likemoji ratings associated with those locations. The Location Rating PFobject (506b) is queried from the Parse Core and the top 3 icons for each location are presented to the user.

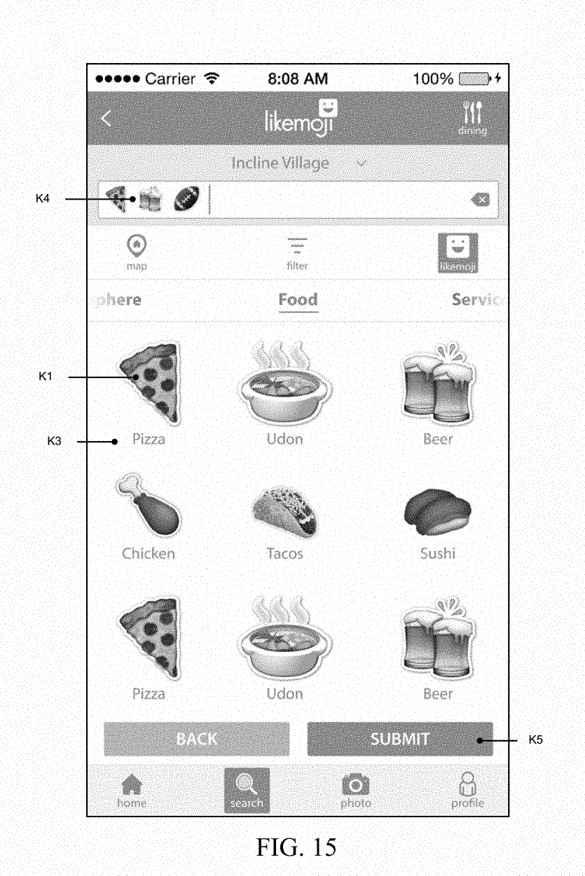

Referring now to FIG. 15, in some embodiments of the Mobile Application can be used to search for restaurants using Likemoji icons. In this example of one embodiment, a user can enter Likemoji icons to search for the best rated place to have pizza, beer, and watch sports.

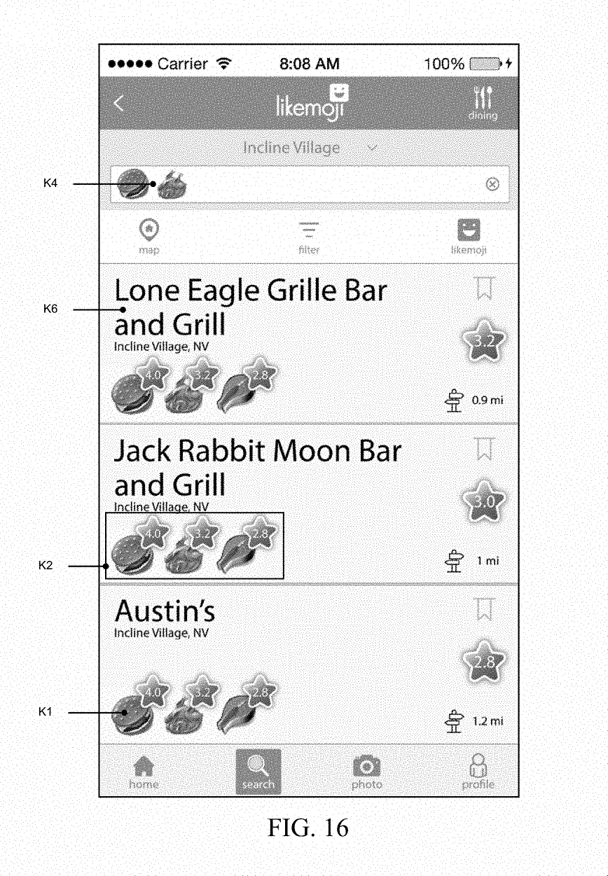

Referring now to FIG. 16, in some embodiments, the Mobile Application includes a Likemoji Icon based search for restaurants and presents search results to the user. The user can see restaurant that have been previously rated and rank highly for, in this example, hamburgers and chicken.

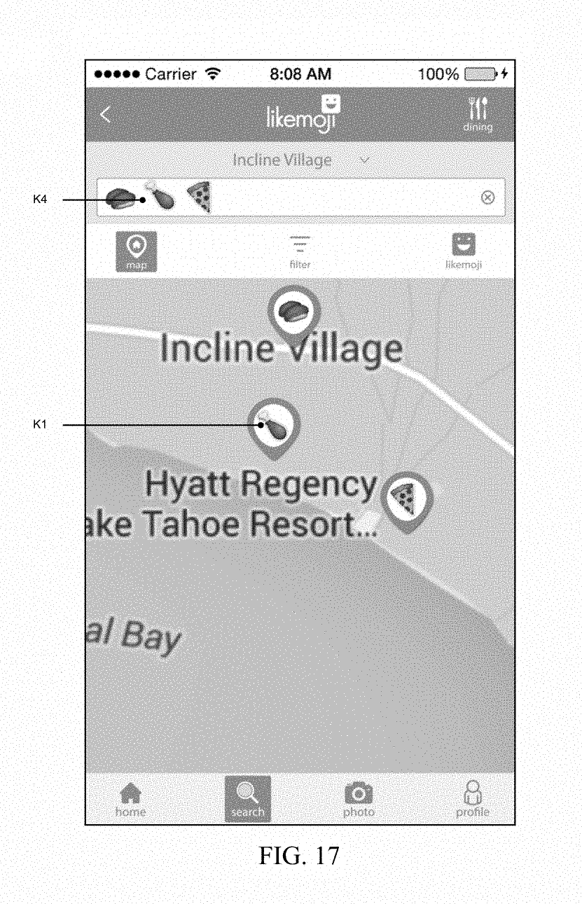

Referring now to FIG. 17, in some embodiments, the Mobile Application includes a Likemoji Icon based search for restaurants where the highest ranking search results for the selected attributes (Likemoji Icons) are presented to the user in a map view.

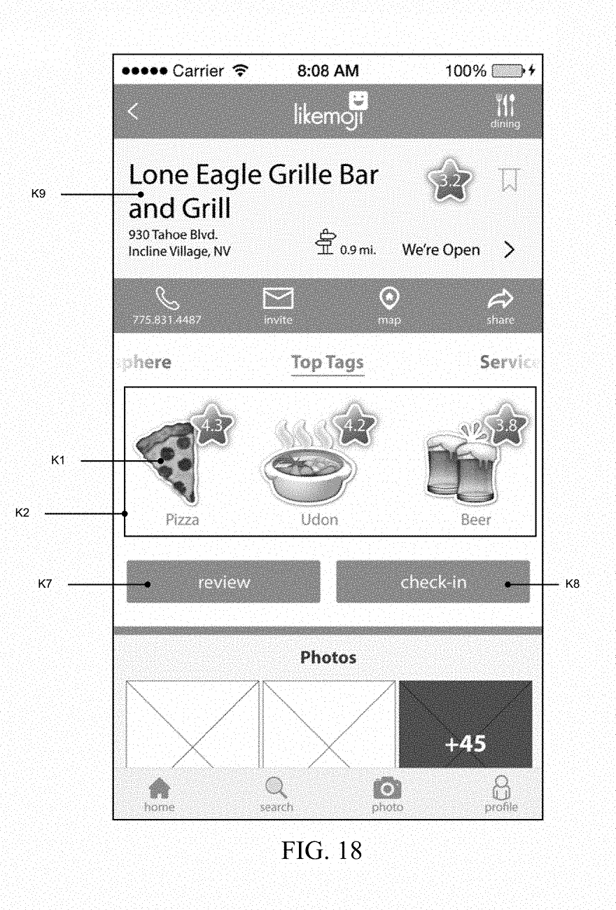

Referring now to FIG. 18, in some embodiments, the Mobile Application displays a detail view of a queried item, showing the top most frequently tagged Likemoji Icons and rating values associated with the location, in this case, the “Lone Eagle Grille.”

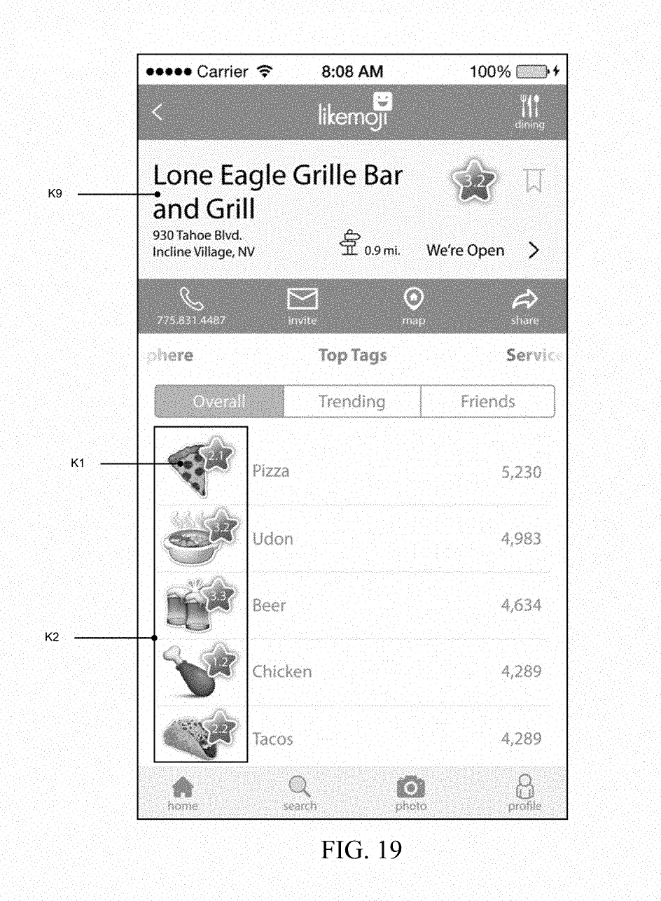

Referring now to FIG. 19, in some embodiments, the Mobile Application displays a detail sub-view of a selected item. This sub-view can display one or more Likemoji ratings associated with a specific location. The ratings can be sorted by, for example, Overall (most ratings), Trending (algorithm), or Friends which displays any tags that have been contributed by friends user accounts that have been linked to the current user's account.

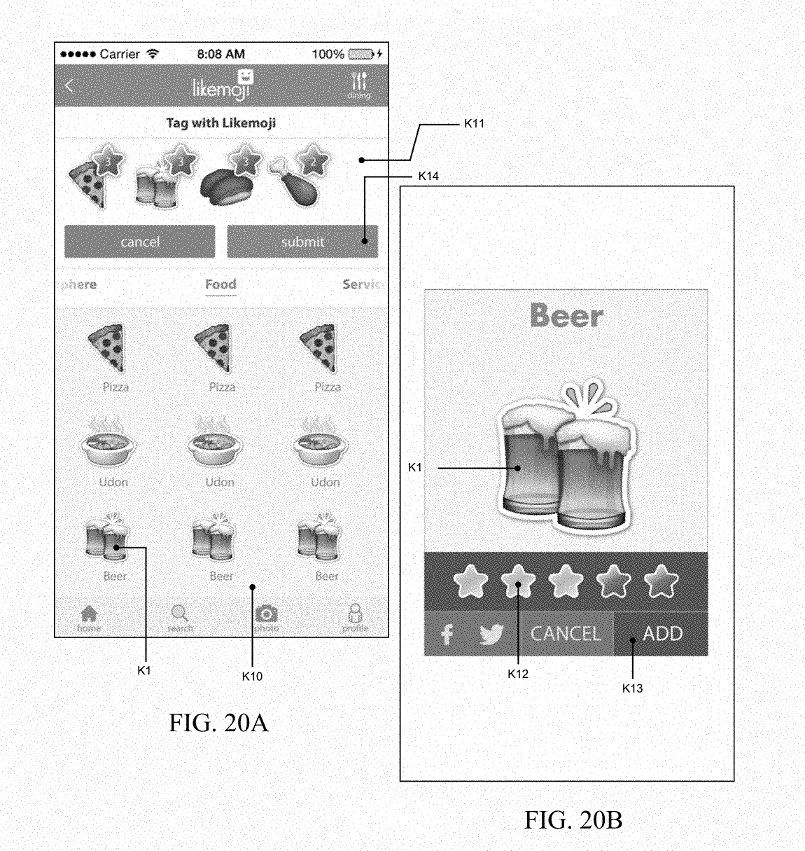

Referring now to FIG. 20A and FIG. 20B, in some embodiments, the Mobile Application displays various food related Likemoji Icons to tag to a specific location. When an Icon is selected, a subwindow is displayed for assigning the associated ratings, such as, for example, a rating using stars.

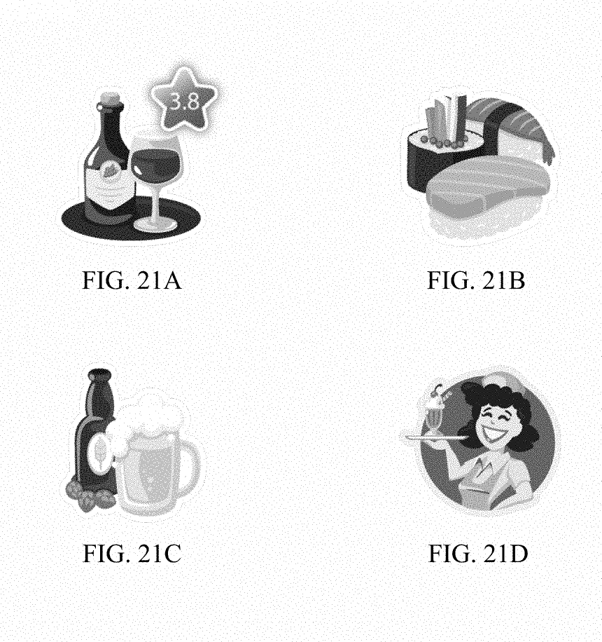

Referring now to FIG. 21A through FIG. 21D, in some embodiments, a variety of Likemoji Icons of can be rendered on a client device.

The Likemoji icons of this disclosure are distinct from traditional emojis in that the Likemoji icons communicate specific concepts, reviews, and opinions rather than just basic, one-dimensional emotions, or literal icon objects or word based translations. Likemoji icons can provide a fast way to communicate and share opinions and reviews with a higher degree of specificity, granularity, or both.

In some embodiments, the network-based graphical communication system allows users to be able to search for internet based content and specific subject matter using aggregated, user sentiment driven, Likemoji icon data. This creates a new way to search for content based on aggregated crowdsourced sentiment.

In some embodiments, the network-based graphical communication system utilizes a visual, structured taxonomy, collecting user based sentiment about specifics that are deemed pertinent by the user in a structured format that is easily aggregated to represent specific consensus sentiment among all reviewers (users). The aggregated specific user sentiment is curated for display based on popular consensus opinion and ranking of specific commonly tagged attributes (Likemoji icons).

In some instances, network-based graphical communication system provides users a structured, visual way to quickly express their opinion and to also see the graphically represented opinions of others at a glance. In some embodiments, users can quickly identify specific key attributes of a given subject matter, by viewing aggregated graphical community opinions and ideas that have been previously tagged to the subject matter of interest. In some instances, users can also search for content or specific subject matter using Likemoji icons. The results provided are based on aggregated community sentiment collected from previous user input.

In certain implementations, user generated data collected by the network-based graphical communication system can be used to create robust subject matter profiles. In the disclosed embodiment, the subjects include locations such as restaurants and bars. These user generated profiles are displayed to other users to provide insight on the core user community sentiment regarding attributes specific to a given location or business. Additionally, the data can be used for in depth analytics and business related strategies.

Just as subject matter profiles can be created using data collected within the network-based graphical communication system, user audience profiles can also be derived based on unique user activity, ratings, and sentiment that they have contributed to the network-based graphical communication system. These user profiles can be used for advanced targeted marketing campaigns, market research, user engagement, and other business related benefits.

In one embodiment, network-based graphical communication system includes, but is not limited to, one or more of the listed components and elements below:

Components:

(a) Client-Side Application

The Client-Side Application are instructions running on a Client-Side Device (b) that provides a user interface for client-side user interaction with the network-based graphical communication system. User Interaction includes but is not limited to: rating Locations using Likemoji Icons (k1), viewing location Likemoji ratings, details, maps, and photos, checking in, and other system related user-facing information and activities.

(b) Client-Side Device

A Client-Side Device such a mobile device, wearable, or computer execute the Client-Side Application (a) allowing Client-Side users to interact with the network-based graphical communication system.

(c) Administrative Server

The Administrative Server hosts an Administrative Website (d) used for adding, editing, and deleting Likemoji PFOBjects (507b) and other data stored in the Parse Core (e).

(d) Administrative Web site

The Administrative Website (d) is, for example, a Drupal-based site hosted on the Administrative Server (c) and is used for adding, editing, and deleting Likemoji PFOBjects (507b) and other data stored in the Parse Core (e).

(e) Parse Core backend as a service (other embodiments could use backend systems such as a combination of load balancers, web application layer, and servers hosting databases).

The Parse Core is a backend as a service solution for the network-based graphical communication system. Data can be saved to the Parse Core, edited, and queried by the Client-Side application using tools and functionality provided in the Parse SDK (software development kit). Data stored in the Parse Core can also be processed using cloud code jobs. It will be understood by one skilled in the art that other backend stack and database systems could be used in place of the functionality provided by the Parse Core backend as a service.

(f) Network (e.g., Https Communication or Similar)

The Network is used to transmit data between the Client-Side applications and the Parse Core. The Network is also used to transmit data between the Parse Core and the Administrative Server and Website.

(g) Third-party data provider API (e.g., Factual, or a similar system to provide ID's and meta-data for a given subject of interest, for example, places, people, products, services, etc.)

In some instances, a third-party data provider API supplies the network-based graphical communication system with subject matter to be displayed to, and interacted with by, the Client-Side user. In the case of Factual, location-based data is associated with Likemoji rating data that users have tagged to a location ID. It's understood that other embodiments of the network-based graphical communication system may provide subject matter and data to the Client-Side user without the use of a 3rd party data provider or API.

(h) Administrative Parse Module

In some embodiments, the Administrative Parse Module is a PHP module used to by the Administrative Website (d) to communicate with the Parse Core API.

In certain implementations, the Client-Side Application includes one or more of the following user interface elements:

(k1) Likemoji Icon UI Elements

Likemoji Icon UI elements are the graphical representation of Likemoji Icons. In one embodiment, they include graphical icons that in some instances are paired with, for example, stars, a numerical rating, or both.

(k2) Location Ratings Display Area

Location Ratings Display Areas can be used throughout the application in various view controllers to display Location Ratings (506b) data represented using Likemoji Icon UI elements (k1). The Location Ratings PFOBject (506b) contains aggregated Likemoji Rating data in the trending tags array. The Location Ratings trending tags array is ordered by the most commonly to the least commonly tagged Likemoji Icons using cloud code actions in the Parse Core (e). The Likemoji Icon UI Elements (k1) displayed in the Location Ratings Display area reference the Location Rating (506b) trending tags array order, and the Likemoji Icon ratings are displayed in this order. In some view controllers, only the first few Likemoji Icons in the trending tags array are represented. In some view controllers, the Likemoji Icons displayed in the Location Ratings Display Area are based on user based search criteria rather than the trending tags array order.

(k3) Likemoji Search Selection Area

In some implementations, the Likemoji Search Selection Area contains Likemoji Icons (k1) that the user can select to conduct a search for locations that have been rated highly for a particular Likemoji Icon or Icons.

(k4) Likemoji Search Field

In certain instances, the Likemoji Search Field displays selected Likemoji Icons representing the User's search criteria.

(k5) Likemoji Search Submit Button

In some implementations, the Likemoji Search Submit Button is used to search for locations based on the Likemoji Icon search criteria displayed in the Likemoji Search Field (k4).

(k6) Likemoji Search Results

In certain cases, the location search results from a Likemoji based search are displayed to the user in this area.

(k7) Detail View Likemoji Review Button

Detection of a button event can trigger an IBAction used to launch the Place Tagging (410) view controller.

(k8) Detail View Check-in Button

Detection of a button event can trigger an IBAction used to launch the Check In (408) view controller.

(k9) Location Detail Display Area

This is an area in the Detail View (403) view controller where location specific meta data is displayed.

(k10) Likemoji Tagging Selection Area

This area holds Likemoji Icons (k1) in the Place Tagging (410) view controller using a collection view. A user can select specific Likemoji icons to rate a location. When a Likemoji Icon is selected, the didSelectItemAtIndexPath: Swift function is triggered and the Likemoji Rating Selector (k12) presented.

(k11) Likemoji User Tags Display Area

The Likemoji User Tags Display Area shows the user added ratings to be submitted to the network-based graphical communication system.

(k12) Likemoji Rating Selector

The Likemoji Rating Selector is presented when a user selects a Likemoji Icon in the Likemoji Tagging Selection Area. Here the user can select the rating to be applied for the selected Likemoji Icon.

(k13) Likemoji Rating Add Button

The Likemoji Rating Add Button allows the user to add a Likemoji rating to the Likemoji User Tags Display Area.

(k14) Likemoji User Tags Submit Button

Detection of a button event can trigger an IBAction that submits tags in the Likemoji User Tags Display Area. These user tags are passed to the Detail View (403) view controller and then sent over the network to be stored as PFObjects in the Parse Core.

(k15) Around Me Result

Around Me Result is an example of a location result based on a query to the Factual and Parse APIs representing data associated with a location near the Client-Side Device (b).

Application and Backend System Elements:

(180) Apple Xcode IDE

The Xcode IDE is an Apple development environment that provides tools used for the development of the mobile iOS application.

(181) Apple Xcode Project

The Xcode Project is a repository for all the files, resources, and information required to build the mobile iOS application.

(182) Swift Programming Language

Swift is the programming language chosen for use in the Apple Xcode project and used for most of the code used by the mobile iOS application.

(183) Parse SDK/Associated Frameworks and Supporting Files

The Parse SDK is a software development kit that provides methods and functions used for integration with the Parse API.

(184) Facebook SDK/Associated Frameworks and Supporting Files

The Facebook SDK is a software development kit that provides methods and functions used for integration with Facebook API.

(185) Third-Party Data Provider SDK (e.g., Factual)/Associated Frameworks and Supporting Files.

The Factual SDK is a software development kit that provides methods and functions used for integration the Factual API.

(200) App Delegate

A mobile application swift file containing methods that dictate behaviors pertaining to the current state of the application.

(300) Storyboard

A graphical user interface present in the Xcode IDE used for graphically laying out and organizing view controllers and their corresponding relationships.

(400) View Controllers

View controllers are visual representations of views displayed within the application and the associated code and logic that provide a specific views functionality.

(401) Loading and Sign Up

Swift files that control loading, login, and sign-up functionality using tools provided by the Facebook and Parse software development kits (SDKs).

(402) Front Page

This swift file controls displaying places around the user, associated Location Ratings (506b), Social Feed, and other interface functionality. Data used within this view controller is queried using the Factual and Parse APIs by way of functionality provided by the respective SDKs.

(403) Detail View

This swift file controls displaying details about a specific location and other interface functionality. Data used within this view controller is passed from the originating view controller and combined with additional data queried from the Parse API by way of functionality provided by the respective SDKs. Various user interaction data is passed from other view controllers to the Detail View Controller. The Detail View Controller references the Parse Model Activity Class (502a) and uses the Parse SDK functionality to transmit data to the Parse Core API where it is stored as an Activity PFObject (502b).

(404) Place Detail Subviews

This is a folder containing view controllers that are used as subviews within the Detail view controller.

(405) Place Photo Detail

This swift file controls displaying a collection view of all photos of a specific location and other interface functionality. Data used within this view controller is passed from the originating view controller.

(406) Place Likemoji Detail.

This swift file controls displaying a table view of Location Ratings (506b) providing detailed Likemoji rating info and other interface functionality. Data used within this view controller is passed from the originating view controller.

(407) Place Map Detail

This swift file controls displaying a map view a specific location and other interface functionality. Data used within this view controller is passed from the originating view controller.

(408) Check In

This swift file controls displaying an interface for the user to check in to a specific location and provide a comment as well as other interface functionality. Data used within this view controller is passed from the originating view controller. The Check In View Controller references the Parse Model Check In Class (508a) and uses the Parse SDK functionality to transmit data to the Parse Core API where it is stored as an Check In PFObject (508b).

(409) More Info

This swift file controls displaying additional information for a specific location and other interface functionality. Data used within this view controller is passed from the originating view controller.

(410) Place Tagging

This swift file controls displaying an interface for the user to tag Likemoji icons to a specific location as well as other interface functionality. Data used within this view controller is passed from the originating view controller. The Place Tagging View Controller references the Parse Model User Tag Class (504a) and Parse Model Location Tag Class (505a) and uses the Parse SDK functionality to transmit data to the Parse Core API where it is stored as User Tag PFObject (504b) and Location Tag PFObject (505b) respectively.

(411) Camera

This swift file controls displaying the camera and photo library access for the user to generate or attach a photo to a specific location and other interface functionality. Data used within this view controller is passed from the originating view controller. Data collected by the Camera view controller will be passed to the Select Place or Photo Actions view controller.

(412) Select Place

This swift file controls displaying a table view of nearby locations from Factual for the user select and attach a photo to a specific location and other interface functionality. Data used within this view controller is passed from the originating view controller. Data collected by the Select Place view controller will be passed to the Photo Actions view controller.

(413) Photo Actions

This swift file controls displaying a photo to be attached to a specific location and a text field for user comment input along with other interface functionality. Data used within this view controller is passed from the originating view controller. The Photo Actions View Controller references the Parse Model Photo Class (503a) and uses the Parse SDK functionality to transmit data to the Parse Core API where it is stored as a photo PFObject (503b).

(414) Profile

This swift file controls displaying a user profile and user input and profile editing functionality along with other interface functionality. Data used within this view controller is queried from the Parse and Facebook APIs by way of functionality provided by the Parse and Facebook SDKs.

(415) Search

This swift file controls displaying a user interface for search functionality along with other interface functionality. Data used within this view controller is queried from the Parse and Factual APIs by way of functionality provided by the Parse and Factual SDKs.

(500) Parse Model Class

These swift files provide a reference data structure for creating Parse PFObjects.

(501a) User Model Class

This swift file provides a reference data structure for creating User PFObjects.

(501b) Parse Class User PFObject Data Structure

This is the data structure of attributes unique to the User PFObject created and stored in the parse core. The User PFObject is used for user account authentication and throughout the application to save and retrieve various data points relative to a specific user's profile.

(502a) Activity Model Class

This swift file provides a reference data structure for creating Activity PFObjects.

(502b) Parse Class Activity PFObject Data Structure

This is the data structure of attributes unique to the Activity PFObject created and stored in the parse core. The Activity PFObject stores data related to user activity generated throughout the application.

(503a) Photo Model Class

This swift file provides a reference data structure for creating Photo PFObjects.

(503b) Parse Class Photo PFObject Data Structure

This is the data structure of attributes unique to the Photo PFObject created and stored in the parse core. The Photo PFObject stores a photo and metadata specific to the photo.

(504a) User Tag Model Class

This swift file provides a reference data structure for creating User Tag PFObjects.

(504b) Parse Class User Tag PFObject Data Structure

This is the data structure of attributes unique to the User Tag PFObject created and stored in the parse core. The User Tag PFObject stores user contributed likemoji rating data and the specific subject ID for the content being tagged.

(505a) Location Tags Model Class

This swift file provides a reference data structure for creating Location Tag PFObjects.

(505b) Parse Class Location Tags PFObject Data Structure

This is the data structure of attributes unique to the Location PFObject created and stored in the parse core. The Location Tag PFObject is a place-specific class that stores multiple users/′ Likemoji ratings in separate arrays for each Likemoji icon.

(506a) Location Rating Model Class

This swift file provides a reference data structure for creating Location Rating PFObjects.

(506b) Parse Class Location Rating PFObject Data Structure

This is the data structure of attributes unique to the Location Rating PFObject created and stored in the parse core. The Location Rating PFObject stores place-specific aggregated rating data averaged and ordered by an after save cloud code function that references the Location Tags PFObject (505b).

(507a) Likemoji Model Class

This swift file provides a reference data structure for creating Likemoji PFObjects.

(507b) Parse Class Likemoji PFObject Data Structure

This is the data structure of attributes unique to the Likemoji PFObject created and stored in the parse core. The Likemoji PFObject stores the name, category, images and other metadata pertaining to individual Likemoji icons used throughout the network-based graphical communication system.

(508a) Check in Model Class

This swift file provides a reference data structure for creating Check In PFObjects.

(508b) Parse Class Check in PFObject Data Structure

This is the data structure of attributes unique to the Class PFObject created and stored in the parse core. The Check In PFObject stores the name, category, images and other metadata pertaining to individual Likemoji icons used throughout the network-based graphical communication system.

(600) Data Class Functions

These classes are used to retrieve data and pass it throughout the application. Network requests get data from parse and local cache queries retrieve data stored on the parse local data store. The Cache layer stores data in a cache to update user interface elements without making an additional network request.

(601) Cache Layer

The Cache Layer class contains functions relating to NSCache and are used to update the UI without making a network request. For example, a user pushes a UI button to like a photo. The photo like count stored in the Cache later is incremented by 1 and the new count is displayed to the user without conducting an additional network request.

(602) Network Requests

The Network Requests class contains methods used to communicate with Parse. These custom methods are created based on specific data and data structures relating to PFObjects that may be required in various parts of the application. These methods can be called from various view controllers throughout the application that require the related specific data stored in the Parse Core.

(603) Local Cache Queries

This class is used to query the Parse local datastore. Data that has been saved to the Parse local datastore can be queried using this class.

(700) Helper Class Functions

Helper Class Functions are used within various methods called throughout the application.

(701) Activity Indicator

The Activity Indicator class is used to create and display an activity indicator UI element. This class is used within the application whenever the Activity Indicator UI element is used to displayed to a user to convey application activities such as retrieving or loading and rendering data.

(702) Facebook Login

This class contains all the logic for when a user logs in to the application using a Facebook account. It completes a FB graph call so the application can retrieve Facebook user data. It also then creates and saves a new user PFObject (501b).

(703) Which Device

This class contains an extension that extends the methods of the UIDevice iOS Class. This class is used to determine which device particular device model is running the application allowing the appropriate User Interface elements and associated files to be displayed.

(704) Utility

This class contains utility type methods used in various parts of the application. For example, one of the methods in this class is used for updating the Facebook friends list when a user activates app. Another example is a method used to call a phone number when the user clicks on a “call” button in the detail view controller for a specific location.

(705) Likemoji Constants

This is a class that contains string constants used throughout the app. This class organizes and stores all constants in one place and also allows autocomplete functionality when programming to help the programmer avoid typos for commonly used constants.

(706) Reachability

This class contains a function that determines if the user is connected to wifi, cellular, or not connected at all. This function is called in various places within the application to gather connectivity related information about the state of the user's device.

(707) Factual (Objective C files and Bridging Header)

These are Objective C files used to integrate the Factual API functionality within a Swift application.

(708) Image with Color

This helper class has a function that allows the application change the appearance of an image.

(709) Tab Bar Controller

This class subclasses the tab bar functionality standard in Swift iOS applications. This class provides additional custom actions for the tab bar.

(800) Custom Cells

Custom cells are subclassed from either UITableViewCell or UICollectionViewCell, respectively. These cells are subclassed to provide additional user interface customization.

(801) Camera Flow

This is a folder containing the PlaceForCameraTableViewCell custom cell. This cell is used on the SelectPlaceForCameraViewController.

(802) Front Page

This is a folder containing FrontPageItemTableViewCell, FrontPageCollectionViewCell, and MyFeedPhotoTableViewCell. All 3 of these custom cells are used on the Front Page (402) view controller to control all the various custom views.

(803) Photo Detail

This folder contains the custom cells for the Photo Detail View Controller.

(804) Photo Detail Table View

This cell is used represent a specific photo and the corresponding user contributed data such as comments, likes, views and other content.

(805) Sign Up Collection View

This is the custom collection view cell for the sign up screen that will have on boarding slides used to convey application functionality to a new user.

(806) Locations Collection View

This is custom table view cell used for listing locations on the Select Place (412) view controller.

(807) Tagging Collection View

This is the custom collection view cell used for displaying Likemoji icons that can be selected by a user when rating or “tagging” a location.

(808) Place Detail Photo Collection View

This is collection view cell for displaying photos associated with a place in the Place Photo Detail (405) view controller.

(809) Place Detail Likemoji Table View

This is table view cell used to display Likemoji icons associated with a location in the Place Likemoji Detail (406) view controller.

(900) Frameworks

These are libraries that provide specific functionality for the application. These files are imported to Xcode project in the Xcode IDE.

(901) FactualSDK.Framework

This is the framework from Factual used for accessing the Factual API. It contains methods and files used for communication with the API.

(902) FB SDKShareKit.Framework

This is a Facebook provided framework that contains methods and files that are used to allow a user to share content to Facebook from the application.

(903) FBSDKCoreKit.Framework

This is a Facebook provided framework used for Facebook SDK functionality.

(904) FBSDKLoginKit.Framework

This is a Facebook provided framework used for logging in to the application using a Facebook account.

(905) Social.Framework

This framework is used to integrate the application with supported social networking services.

(906) Accounts.Framework

This is an Apple framework used to access user accounts stored in the accounts db.

(907) Libsqlite3.Tbd

This file provides Parse local datastore functionality allowing the application to store data locally on the client-side device.

(908) Liz.Tbd

This file is used to enable Parse local datastore functionality.

(909) SystemConfiguration.Framework

This framework provides functions used by the application to determine client-side device connectivity.

(910) StoreKit.Framework

This is a Framework required by Parse that provides payment request functionality.

(911) Security.Framework

This framework provides security related functionality used for controlling access to the application and the associated data.

(912) QuartzCore.Framework

This iOS framework is used to provide functionality used for animation and other ui elements.

(913) CoreLocation.Framework

This iOS framework allows the application to determine the location of the client-side device.

(914) CoreGraphics.Framework

This iOS framework is used by the application to display graphic elements.

(915) CFNetwork.Framework

This is a Parse framework that provides a library of abstractions used for network protocols.

(916) AudioToolbox.Framework

This is a Parse framework that provides interfaces for managing audio sessions.

(917) ParseFacebookUtilsV4.Framework

This framework allows the FBSDKLoginKit.framework (904) to be used by Parse to provides Facebook user data for the creation of new User PFObjects (501b).

(918) ParseTwitterUtils.Framework

This Parse framework is used for user account integration with Twitter.

(919) ParseUI.Framework

This is a Parse framework that contains PFImageView which subclasses UIImageView allowing the application to use Parse PFFiles.

(920) Bolts.Framework

This is used with Parse to manage asynchronous tasks when communicating with the Parse server.

(921) Parse.Framework

This Parse framework provides SDK functionality used to create and call various PFObjects.

(1000) Supporting Files

This folder includes font files, the info.plist which tells the application certain things/behaviors, the launch screen xib (what will show up while app is loading), and the folder containing all the image files.

Component Relationships:

In some embodiments, a Client-Side Application (a) is hosted and run on a Client-Side Device (b). The Client-Side Application communicates with the Parse Core API (e) over a Network (f) using functionality provided by the Parse software development kit. The Parse Core API (e) stores data received from the Client-Side Application (a) to the Parse Core NoSQL database. Data stored in the Parse Core (e) is queried by and returned to the Client-Side Application (a) over the Network (f) using functionality provided by the Parse software development kit.

An Administrative Server (c) is used to host an Administrative Website (d) and a custom Administrative Parse Module (h) used to communicate over a Network (f) with the Parse Rest API (e). The Administrative Website (d) is used to create, edit, and delete Likemoji Icons that are stored in the Parse Core (e). Once added, the Likemoji Icons are accessible for use within the network-based graphical communication system and can be queried over the Network (f) for use by the Client-Side Application (a).

A Third-Party Data Provider (g) such as Factual is used to provide location related data pertaining to, for example, restaurants, bars, hotels, and other business. This Data is queried from the Factual API over the Network (f) by a Client-Side Device (a). The Data received from the Third-Party Data Provider (g) can be paired with data that has been queried over the Network (f) from the Parse Core (e) and displayed to a user on the Client-Side Device. It's understood that various 3rd Party Data Provider (g) services could be used to provide a variety of different types of subject matter to be displayed to a Client-Side Application (a) user and rated using the network-based graphical communication system. In some embodiments, subject matter data can be provided by the Parse Core (e) or another backend database system and may not involve the use of a Third-Party Data Provider (g) service.

A Client-Side Application (a) running on a Client-Side Device (b) is used to display subject matter content (in this case location or business information), paired with Likemoji Rating Data to the client-side end user. In one embodiment, data is stored in the Parse Core (e), and Factual 3rd Party Data Provider (g) and is queried over the Network (f) by the Client-Side Application (a) using functionality provided by the Parse and Factual software development kits. The data is received by the Client-Side iOS Application and rendered to the user. Data from Factual pertaining to specific locations is displayed and paired with aggregated user generated Likemoji rating data associated with a specific given location. In some embodiments, this provides users of the network-based graphical communication system with a quick way to see core attributes and aggregated user generated sentiment pertaining to those attributes about a given location.

In some embodiments, users of the Client-Side Application (a) can also contribute their own opinions to the network-based graphical communication system by tagging Likemoji Icons and associated ratings to a specific location. This user generated tag data is sent by the Client-Side Application (a) over the Network (f) to the Parse Core (e) where it is stored in PFObjects (Parse database objects) that contain Factual location ID's, specific Likemoji tag and corresponding rating data, and other relevant data. In some embodiments, this provide users of the network-based graphical communication system a quick way to share their own ratings or specific opinions about a subject of interest with other users of the network-based graphical communication system.

In some implementations, Likemoji PFobjects (507b) (Parse Class Database Objects) are created using a Administrative web client (d) running on an Administrative Server (c). The Administrative Server (c) submits Likemoji icon object data from a webform running on the Administrative Server to the Parse REST API using an administrative parse module (h). The Parse REST API transmits the Likemoji Icon object data to the Parse Core Database (e) and a new Likemoji PFobject (507b) is created. Similarly, Likemoji PFobjects (507b) can be edited using the Administrative Server (c), administrative web client (d), and administrative parse module (h). Likemoji PFobjects (507b) stored in the Parse Core (e) can be queried by Client-Side Applications (a) over the Network (f).

A new user installs the Client-Side Application (a) on, for example, an iOS Client-Side Device (b) after they have downloaded it from, for example, the App store. When the Client-Side Application (a) is launched for the first time the Loading and Sign Up (401) view controllers are displayed to the user. The Client-Side Application (a) queries the Parse API over the network (f) for all Likemoji (507b) PFObjects stored in the Parse Core (e). Likemoji PFObject data is returned to the Client-Side Application (a) and stored in the local data store for later use.

The user is prompted to create a new account by signing up with a Facebook Account using functionality provided by the Facebook SDK or by entering an Email address and new password. The Sign Up (401) view controller references the Parse User Model Class (501a) and uses Parse SDK functionality to send the data over the Network (f) to the Parse Core (e) where a new User (501b) PFUser database object is created.

After a user account has been created, the user is logged in and the Client-Side Application segues to the Front Page (402) view controller. The first time the Front Page (402) view controller loads, the application requests the user's permission to use CoreLocation. CoreLocation retrieves the coordinates of the Client-Side Device (b) using the Swift method didUpdateLocations. The Front Page (402) view controller sends the Client-Side Device (b) coordinates over the Network (f) as a query the Factual API (g). Location data provided by Factual (g) is returned to the Client-Side Device (b) where it is stored locally as a Place Object for later use. The Front Page (402) view controller uses Factual IDs in a query over the Network (f) to the Parse Core. Data from Location Rating (506b) PFObjects that contain the matching Factual IDs from the query is returned over the network (f) to the Client-Side application (a) where it is also stored in the Places Object. Location data stored within the Places Object is rendered to the user in the Around Me Results (k15) on the Front Page (402) view controller and the associated Location Rating (506b) data is displayed as Likemoji Icon UI Elements (k1) in the Location Ratings Display Area (k2).

When the user selects an Around Me Result (k15) displayed in the Front Page (402) view controller, the Swift didSelectRowAtIndexPath: method triggers a segue to the Detail View (403) view controller and the Places Object data is passed to the Detail View (403) view controller. Data from the Location Rating (506b) PFObject stored in the Places Object is displayed to the user on the Detail View (403) view controller in the Location Ratings Display Area (k2). The Location Detail Display Area displays other data contained in the Places Object such as the place name and geographic location.

When a user touches the Review Button (k7) a segue to the Place Tagging (410) view controller is triggered by a Swift IBAction. The Place Tagging (410) view controller displays Likemoji PFObject (507b) data from the local data store as Likemoji Icon UI Elements (k1) in a UICollectionView. Here the user can select a Likemoji Icon and the Swift didSelectItemAtIndexPath: method unhides a popup sub view that displays the Likemoji Rating Selector (k12) and the Likemoji Rating Add Button (k13). The Likemoji Rating Selector (k12) contains star buttons that allow the user to set a rating value for the respective Likemoji Icon. When the user touches the Likemoji Rating Add Button (k13) a Swift IBAction triggers a method that hides the popup sub view and appends the Likemoji PFObject (507b) ID and rating to a Swift dictionary in the Place Tagging (410) view controller. When the user touches the Likemoji User Tags Submit Button (k14) an IBAction triggers a method that transmits the Swift dictionary along with the corresponding location ID and user data over the Network (f) to the Parse Core (e) where it is stored in User Tag (504b) and Location Tag (505b) PFObjects. The Location Tag (505b) data is used by cloud code actions performed in the Parse Core (e) to generate the Location Rating (506b) PFObjects. JavaScript Cloud code actions use trending and overall algorithms to average ratings for each Likemoji Tag Array stored in the Location Tag (505b) PFObject. The trending and overall averages are appended to arrays stored in Location Rating (506b) PFObjects and are available for future queries. The Likemoji User Tags Submit Button (k14) IBAction also triggers a segue back to the Detail View (403) view controller.

Search can be conducted using Likemoji Icon UI Elements (k1) based on aggregated Likemoji user data stored Location Rating (506b) PFObjects. A search button located in the Tab Bar at the bottom of all view controllers triggers a segue to the Search (415) view controller. The Search (415) view controller displays Likemoji PFObject (507b) data from the local data store as Likemoji Icon UI Elements (k1) in a UICollectionView. Here the user can select a Likemoji Icon and the Swift didSelectItemAtIndexPath: method and the Likemoji PFObject (507b) ID is added to the search criteria and displayed to the user in the Likemoji Search Field (k4). Once the user has selected one or more Likemoji icons to search by and has established the search criteria in the Likemoji Search Field (k4), they can submit the search by pushing the Likemoji Search Submit Button (k5). The Likemoji Search Submit Button (k5) triggers a Swift IBAction that queries the Location Rating (506b) table in the Parse Core (e) with a GeoPoint and radius. Location Rating PFObjects within the GeoPoint Radius are returned over the Network (f) to the Client-Side Application, filtered by the likemoji search criteria and displayed as Likemoji Search Results (k6) in the Search (415) view controller.

It will be understood by one skilled in the art that other content, functions, buttons, view controllers, and corresponding features can be presented and used within the Client-Side application, and that various other embodiments of the network-based graphical communication system, including Client-Side Applications (a), such as websites, mobile devices, smart watches, smart devices, and other user interfaces, could make use of similar data structures and design functionality as disclosed in this embodiment.

A visual taxonomy of Likemoji Icon UI Elements (k1) representing various attributes of things is graphically designed, named, and categorized. The Likemoji Icon UI Elements (k1) designs are then exported to a file format that can be rendered by the Client-Side Application (a).

An Administrative Website (d) is created using, for example, Drupal and deployed to an Administrative Server (c). This Website allows the Likemoji Icon UI Element (k1) images, Likemoji Icon name, category, and other Likemoji Icon class related data to be entered into a web form and submitted through an Administrative Parse Module (h) that transmits data over the Network (f) to the Parse Core Backend (e) where a new Likemoji Icon (507b) PFobject is created and stored. The administrative website (d) can also be used to edit and delete existing Likemoji Icon (507b) PFobjects from the Parse Core Backend (e).

Custom Classes are created on the Parse Core Backend (e) to store and categorize User (501b), Activity (502b), Photo (503b), User Tag (504b), Location Tag (505b), Location Rating (506b), Likemoji (507b), and Check In (508b) PFObjects. The data is accessible to client-side queries made over a Network (f). The client-side queries are made to the Parse Core Backend (e) utilizing the Parse software development kit.

A Client-Side Application (a) is created using the Apple XCode IDE. Using the Xcode IDE (180), a new Xcode Project (181) is created and the Swift Programming Language (182) is selected for use within the project. The Parse, Facebook, and Factual SDKs and Associated Frameworks and supporting files (183) (184) (185) are added to the Xcode Project (181). Client-side user interfaces are graphically designed and integrated into View Controllers (400) containing the various User Interface Elements (k1-k15). View Controllers (400) are organized in the Storyboard (300) and Swift code specific to functionality required by a given View Controller is added to their respective files. Model Class, Data Class, and Helper Class Swift files are created and provide functionality for various parts of the Application as described in the Application Elements sections (500-508a), (600-603), and (700-709). Additional Supporting files are added to the Supporting Files (1000) folder for use by the Xcode Project (181) and Client-Side Application (a).

In some embodiments, instead of writing text, users of the Client-Side Application (a) rate or “tag” internet content or subject matter with Likemoji Icons that describe what they feel or think regarding the currently viewed content. For example, instead of writing a review talking about a specific attribute such as “good battery life”, the user would select and tag content presented in a Detail View (403) view controller with a Likemoji Icon that represents “good battery life” or “battery life (5 stars)”. The system then aggregates, counts and displays most popular emoji (rating information) tagged to a specific subject matter (for example, the battery life of a consumer electronic product). This embodiment could be combined with a text writing assessment facility.

Users of the network-based graphical communication system viewing subject matter that has been previously tagged with Likemoji Icons can see relevant Likemoji Icons which represent aggregated data of popular consensus opinion pertaining to subject matter being viewed. Users can also choose to see trending Likemoji Icons (ratings) for a given subject matter of interest.

Users can also search for things using the network-based graphical communication system by entering at least one Likemoji Icon of interest in the search field. In some embodiments, Likemoji Icons can be combined with other Likemoji Icons or words to return a more specific set of search results. Content previously tagged with Likemoji icons that match the Likemoji icons in the search field appear in the search results. The pages or content that contain the most tags or highest associated ratings of relevant Likemoji Icons to the user's search is displayed in the search results. Users can then select and view a given subject of interest based on crowd-sourced, structured Likemoji data driven search.

In some instances, Data collected from usage of Likemoji Icons that have been tagged to a given subject can provide analytical structured data for market research in regard to specific user opinion, audience profiles, and other metrics of interest.

In some implementations, rewards systems and marketing promotions can be offered to users based on their participation in reviewing any given subject matter of interest (Places, Products, Services, etc.) with the network-based graphical communication system.

Products and services can be offered to users based on the Likemoji Icons they often tag or the products or content they are searching for or tagging with Likemoji icons. An auto response system can be combined with data collected from the network-based graphical communication system providing marketers with a powerful targeted advertising and customer engagement engine. For example, a specific offering could be sent to all customers of a given restaurant that have used the network-based graphical communication system to tag that restaurant with at least 3 service related Likemoji icons. Specific audience profiles and user engagement data (specific in tagging actions) could be combined to trigger a targeted offering or advertisement unique to that user's audience profile.

With the network-based graphical communication system, business can have a new way of engaging with their customers by gaining the ability to act on specific insights, opinions, and customer actions captured by Likemoji Icon rating data gathered within the network-based graphical communication system.

Likemoji icon rating data can also act to unify opinion and ideas regarding similar subject matter across multiple internet pages in different languages. This can help to bridge many language barriers for sharing opinion and ideas, while aggregating the collected data, creating a unified and clear, common voice.

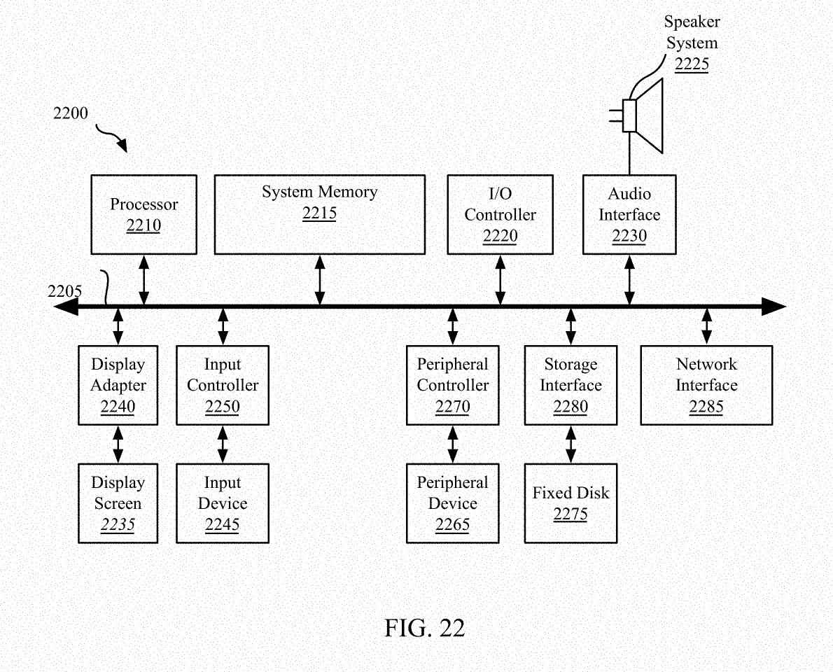

Referring now to FIG. 22, the mobile devices, backend servers, or both (e.g., see FIG. 1) may be an example of a computing device 2200. In one configuration, network-based graphical communication system devices 2200 includes a bus 2205 which interconnects major subsystems of the computing device, such as a processor 2210, a system memory 2215 (typically RAM, but which may also include ROM, flash RAM, non-transitory memory, or the like), an input/output controller 2220, an external audio device, such as a speaker system 2225 via an audio output interface 2230, an external device, such as a display screen 2235 via, in certain cases, display adapter 2240, an input device 2245 (e.g., a Bluetooth connected device), one or more peripheral connected devices 2265 (interfaced with a peripheral device controller 2270), and a storage interface 2280.

Bus 2205 allows data communication between processor 2215 and system memory 2220, which may include read-only memory (ROM) or flash memory (neither shown), and random access memory (RAM) (not shown), as previously noted. The RAM is generally the main memory into which the operating system and logic instructions are loaded. The ROM or flash memory may contain, among other code, the Basic Input-Output system (BIOS) which controls basic hardware operation such as the interaction with peripheral components or devices. Instructions resident with network-based graphical communication system computing devices are generally stored on and accessed via a non-transitory computer readable medium, such as a hard disk drive (e.g., fixed disk 2275) or other storage medium. Additionally, applications may be in the form of electronic signals modulated in accordance with the application and data communication technology when accessed via interface 2285.

Storage interface 2280, as with the other storage interfaces of controller 2200, may connect to a standard computer readable medium for storage and/or retrieval of information, such as a fixed disk drive 2275. Fixed disk drive 2275 may be a part of computing device 2200 or may be separate and accessed through other interface systems. Network interface 2285 may provide such connection using wireless techniques, including digital cellular telephone connection, Cellular Digital Packet Data (CDPD) connection, digital satellite data connection, or the like.

Many other devices or subsystems (not shown) may be connected in a similar manner. Conversely, all of the devices shown in FIG. 22 need not be present to practice the present systems and methods. The devices and subsystems may be interconnected in different ways from that shown in FIG. 22. The aspect of some operations of a system such as that shown in FIG. 22 are readily known in the art and are not discussed in detail in this application. Computer instructions to implement the present disclosure may be stored in a non-transitory computer-readable medium such as one or more of system memory 2220 or fixed disk 2275. The operating system provided on some computing devices 2200 may be, for example, iOS®, ANDROID®, MS-WINDOWS®, UNIX®, LINUX®, OSX®, or another known operating system.

Moreover, regarding the signals described herein, those skilled in the art will recognize that a signal may be directly transmitted from a first block to a second block, or a signal may be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures may be implemented to achieve the same functionality.

The process parameters and sequence of steps described and/or illustrated herein are given by way of example only and may be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification are to be construed as meaning “at least one of.” In addition, for ease of use, the words “including” and “having,” as used in the specification, are interchangeable with and have the same meaning as the word “comprising.” In addition, the term “based on” as used in the specification is to be construed as meaning “based at least upon.”

What is claimed is:

1. A network-based graphical communication system, the system comprising:
a client-side computing device operable to run a client-side application configured to display subject matter content associated with subject matter attribute data, wherein the client-side application comprises one or more of:
a plurality of graphical Likemoji user interface elements;
a Likemoji search field;
a Likemoji search results area;
a Likemoji tagging selection area;
a Likemoji rating selector; and
a location detection service;
a network operable to receive a first digital content from the client-side computing device, transmit a second digital content to the client-side computing device, or both;
an administrative server communicatively coupled to the network wherein the administrative server is configured to receive the first digital content via the network, transmit the second digital content to the client-side computing device via the network, or both;
a location based data service interface; and
a data storage service interface.

2. The network-based graphical communication system of claim 1 wherein the administrative server further comprises a satisfiability rating engine.

3. The network-based graphical communication system of claim 1 wherein the administrative server further comprises a profiling engine configured to generate one or more of subject matter profiles, user profiles, or audience profiles.

4. The network-based graphical communication system of claim 1, wherein one or more of the graphical Likemoji user interface elements comprises one or more of a rating, modifier, or adjective element.

5. The network-based graphical communication system of claim 4, wherein one or more of the rating, modifier, or adjective elements are statically associated and integrated with the digital image or icon.

6. The network-based graphical communication system of claim 4, wherein one or more of the ratings, modifiers, or adjectives elements are dynamically associated and integrated with the digital image or icon.

7. The network-based graphical communication system of claim 4, wherein the one or more ratings comprise a numeric, grade, or badge indicator.

8. The network-based graphical communication system of claim 1, wherein one or more of the graphical Likemoji user interface elements comprises one or more of a proximal rating, modifier, or adjective element.

9. A network-based graphical communication device operable to run an application, the application configured to display subject matter content associated with subject matter attribute data, wherein the application comprises one or more of:
a plurality of graphical Likemoji user interface elements;
a Likemoji search field;
a Likejmoji search results area;
a Likemoji tagging selection area;
a Likemoji rating selector; and
a location detection service;

10. The network-based graphical communication device of claim 9 wherein the Likemoji search results area comprises a map view.

11. The network-based graphical communication device of claim 9 wherein the Likemoji search results area comprises an aggregated consensus opinion.

12. The network-based graphical communication device of claim 9 wherein the Likemoji search field is operable to receive input comprising a plurality of the graphical Likemoji user interface elements.

13. The network-based graphical communication device of claim 9 wherein the Likemoji search field is operable to receive input comprising a combination of words and graphical Likemoji user interface elements.

14. The network-based graphical communication device of claim 9 wherein the a Likejmoji search results area comprises a friend sorted results set.

15. The network-based graphical communication system of claim 9, wherein one or more of the graphical Likemoji user interface elements comprises one or more of a rating, modifier, or adjective element.

16. The network-based graphical communication system of claim 15, wherein one or more of the rating, modifier, or adjective elements are statically associated and integrated with the digital image or icon.

17. The network-based graphical communication system of claim 15, wherein one or more of the ratings, modifiers, or adjectives elements are dynamically associated and integrated with the digital image or icon.

18. The network-based graphical communication system of claim 15, wherein the one or more ratings comprise a numeric, grade, or badge indicator.

19. The network-based graphical communication system of claim 9, wherein one or more of the graphical Likemoji user interface elements comprises one or more of a proximal rating, modifier, or adjective element.
